(19) United States
(12) Patent Application Publication
(10) Pub. No.: US 2026/0025727 A1
(43) Pub. Date: Jan. 22, 2026

(54) Failure Handling during Layer1/Layer 2 Mobility

(71) Applicant: Telefonaktiebolaget LM Ericsson (publ), Stockholm (SE)

(72) Inventors: Pontus Wallentin, Linköping (SE); Icaro Leonardo Da Silva, Solna (SE); Antonino Orsino, Kirkkonummi (FI); Liwei Qiu, Täby (SE)

(21) Appl. No.: 18/993,058

(22) PCT Filed: Aug. 4, 2023
(86) PCT No.: PCT/SE2023/050776

§ 371 Date: Jan. 10, 2025

Related U.S. Application Data
(60) Provisional application No. 63/396,518, filed on Aug. 9, 2022.

(51) Int. Cl. H04W 36/30; H04W 24/00

(52) U.S. Cl. CPC H04W 36/305; H04W 24/00

(57) ABSTRACT

A method, system and apparatus are disclosed. A wireless device configured with an inter-cell mobility configuration for handling radio related failures is provided. The wireless device attempts to execute the first inter-cell mobility change procedure with a first target network node of a first inter-cell mobility candidate target cell associated with the inter-cell mobility configuration. The wireless device determines a radio related failure associated with the first target network node, the first inter-cell mobility candidate target cell, and/or the inter-cell mobility change procedure. The wireless device performs at least one wireless device action based on the inter-cell mobility configuration and the determined radio related failure.

### TECHNICAL FIELD

The present disclosure relates to wireless communications, and in particular, to failure handling during Layer 1 (L1)/Layer 2 (L2) Mobility.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WDs), as well as communication between network nodes and between wireless devices. Sixth Generation (6G) wireless communication systems are also under development.

As part of 3GPP Release 18, further NR mobility enhancements have been considered. A goal of one such enhancement is to specify Open Systems Interconnection (OSI) Layer 1/Layer 2 (L1/L2)-based inter-cell mobility. The following are some example objectives of such enhancement:
To specify mechanism(s) and procedures for L1/L2 based inter-cell mobility for mobility latency reduction, including one or more of:
   Configuration and maintenance for multiple candidate cells to allow fast application of configurations for candidate cells (e.g., RAN2, RAN3);
   Dynamic switch mechanisms among candidate serving cells (including, e.g., SpCellA and SCell) for the potential applicable scenarios based on L1/L2 signaling (e.g., RAN2, RAN1);
   L1 enhancements for inter-cell Beam management, including L1 measurement and reporting, and beam indication (e.g., RAN1, RAN2);
   Timing Advance management (e.g., RAN1, RAN2); and/or
   Centralized Unit (CU)-Distributed Unit (DU) (CU-DU) interface signaling to support L1/L2 mobility, if needed (e.g., RAN3).
Frequency range 2 (FR2) specific enhancements have also be considered.
Some example procedures of L1/L2 based inter-cell mobility may be applicable to various scenarios, e.g., one or more of:
   Standalone, carrier aggregation (CA) and New Radio-Dual Connectivity (NR-DC) cases, e.g., with serving cell change(s) within one cell group (CG);
   Intra-DU case and intra-CU/inter-DU case(s) (e.g., applicable for Standalone and CA, in which no new RAN interfaces may be expected);
   Both intra-frequency and inter-frequency;
   Both FR1 and FR2; and/or;
   Source and target cells may be synchronized or non-synchronized.

For example, 3GPP TS 38.321, v17.1.0 provides the following example goal(s) for the above-described enhancement, and recites as follows:

“When the UE moves from the coverage area of one cell to another cell, at some point a serving cell change needs to be performed. Currently serving cell change is triggered by L3 measurements and is done by RRC signalling triggered Reconfiguration with Synchronisation for change of PCell and PSCell, as well as release add for SCells when applicable. All cases involve complete L2 (and L1) resets, leading to longer latency, larger overhead and longer interruption time than beam switch mobility. The goal of L1/L2 mobility enhancements is to enable a serving cell change via L1/L2 signalling, in order to reduce the latency, overhead and interruption time.”

As an example implementation of the above enhancement, 3GPP work item description RP-221799 considers L1/L2 based inter-cell mobility, but may not specify a procedure or signaling to configure and execute L1/L2 based inter-cell mobility serving cell change. A goal of L1/L2 based inter-cell mobility is to reduce latency, overhead, and/or interruption time.

An additional challenge related to L1/L2 based inter-cell mobility includes ensuring that different kinds of radio related failures, such as radio link failures, handover failures, beam failures and failure to execute a L1/L2 based inter-cell mobility, are handled by the network node and/or the wireless device (e.g., UE).

For example, in some existing wireless communication networks, after a beam failure detected (BFD) event occurs, the wireless device may perform beam failure recovery (BFR), e.g., by selecting a new beam among the candidate beam list to be selected upon BFR, followed by transmission of a BFR MAC CE to the network. BFR may be limited to beams in the current serving cell.

Thus, existing systems may lack adequate signaling and procedures for failure handling during inter-cell mobility, such as L1/L2 based inter-cell mobility.

### SUMMARY

Some embodiments advantageously provide methods, systems, and apparatuses for failure handling during inter-cell mobility, such as L1/L2 based inter-cell mobility. In some embodiments, a wireless device and a method for a wireless device are provided, where the wireless device is configured with at least one configuration of a L1/L2 based inter-cell mobility candidate target cell, and/or is configured to handle radio related failures. In some embodiments, the wireless device, after a radio related failure has been detected/determined, executes a L1/L2 based inter-cell mobility serving cell change procedure, e.g., from a source cell and/or network node to a target cell and/or network node. Some non-limiting examples of radio related failure include:
i) a beam failure detection (BFD), e.g., as defined in 3GPP TS 38.321;
ii) a failure to execute a L1/L2 based inter-cell mobility serving cell change procedure;
iii) a radio link failure (RLF), e.g., expiry of timer T310 or any other timer associated with RLF;
iv) a handover failure (HOF), e.g., expiry of timer T304 or any other timer associated with HOF;
v) maximum number of RLC (re) transmissions (e.g., where the maximum number may be pre-configured in the wireless device and/or network node and/or may be signaled by one entity such as the network node to another entity such as the wireless device); and/or vi) a radio link failure (RLF) e.g., expiry of timer T316 or any other timer associated with RLF.

In some embodiments, the wireless device transmits, to a first (e.g., target) network node and/or second (e.g., target) network node, an indication that the wireless device has executed a L1/L2 based inter-cell mobility serving cell change procedure due to a radio related failure being detected/determined by the wireless device. In some embodiments, the wireless device receives, from the source network node and/or a third network node, a configuration for the wireless device to use in handling radio related failures, including a configuration for execution of a L1/L2 based inter-cell mobility serving cell change procedure after a radio related failure has been detected/determined by the wireless device.

In some embodiments, the wireless device may be configured by the source network node with an indication that the wireless device is allowed to perform the L1/L2 based inter-cell mobility serving cell change procedure upon detection/determination of a radio related failure. Thus, when the radio related failure is detected/determined, the wireless device may only determine to perform a L1/L2 based inter-cell mobility serving cell change procedure if the indication has been configured, in some embodiments. The indication may be configured per L1/L2 based inter-cell mobility candidate target cell.

Some embodiments of the present disclosure provide a source network node and a method implemented in a source network node (e.g., a source gNB, a source Distributed Unit, DU, serving network node such as a serving DU, etc.) for handling radio related failures in a wireless device with at least one configuration of a L1/L2 based inter-cell mobility candidate target cell. In some embodiments, the source network node may configure the wireless device with an indication that the wireless device is allowed to perform the L1/L2 based inter-cell mobility serving cell change procedure upon detection/determination of a radio related failure. In some embodiments, the source network node may receive an indication, from a first network node or second target network node or a third network node, that the wireless device has executed a L1/L2 based inter-cell mobility serving cell change procedure In some embodiments, the source network node transmits, to the wireless device, a configuration for the wireless device to use in handling radio related failures, including configuration of execution of a L1/L2 based inter-cell mobility serving cell change procedure after a radio related failure detected/determined by the wireless device

Some embodiments of the present disclosure also provide methods for a third network node (e.g., serving network node, such as a (serving) Central Unit (CU), (serving) gNB-CU, etc.), for handling radio related failures in a wireless device with at least one configuration of a L1/L2 based inter-cell mobility candidate target cell. In some embodiments, the third network node transmits, to the wireless device and/or a source network node, a configuration for the wireless device to handle radio related failures, including configuration of execution of a L1/L2 based inter-cell mobility serving cell change procedure after a radio related failure detected/determined by the wireless device. In some embodiments, the third network node receives, from a first or second target network node, an indication that the wireless device has executed a L1/L2 based inter-cell mobility serving cell change procedure due to a radio related failure being detected/determined by the wireless device. In some embodiments, the third network node transmits, to a source network node, an indication that the wireless device has executed a L1/L2 based inter-cell mobility serving cell change procedure due to a radio related failure being detected/determined by the wireless device.

Some embodiments of the present disclosure provide a first target network node and methods implemented in a first target network node (e.g., a target gNB, a first target DU, a target gNB-DU, etc.), for handling radio related failures in a wireless device with at least one configuration of a L1/L2 based inter-cell mobility candidate target cell. In some embodiments, the first target network node, when sending a configuration to the serving DU or CU for L1/L2 based inter-cell mobility candidate target cell, may also include in the configuration an indication that the wireless device is allowed to perform the L1/L2 based inter-cell mobility serving cell change procedure upon detection/determination of a radio related failure in this L1/L2 based inter-cell mobility candidate target. In some embodiments, the first target network node receives, from the wireless device, an indication that the wireless device has executed a L1/L2 based inter-cell mobility serving cell change procedure due to that a radio related failure detected/determined by the wireless device. In some embodiments, the first target network node transmits, to a source network node or a third network node, an indication that the wireless device has executed a L1/L2 based inter-cell mobility serving cell change procedure due to a radio related failure being detected/determined by the wireless device.

Some embodiments of the present disclosure provide a second target network node and methods implemented in a second target network node (e.g., a target gNB, a second target DU, a target gNB-DU, etc.) for handling radio related failures in a wireless device with at least one configuration of a L1/L2 based inter-cell mobility candidate target cell. In some embodiments, the second target network node, when sending a configuration to the serving DU or CU for 20 L1/L2 based inter-cell mobility candidate target cell, may also include in the configuration an indication that the wireless device is allowed to perform the L1/L2 based inter-cell mobility serving cell change procedure upon detection/determination of a radio related failure in this L1/L2 based inter-cell mobility candidate target. In some embodiments, the second target network node may receive, from the wireless device, an indication that the wireless device has executed a L1/L2 based inter-cell mobility serving cell change procedure due to a radio related failure being detected/determined by the wireless device. In some embodiments, the second target network node transmits, to a source network node or a third network node, an indication that the wireless device has executed a L1/L2 based inter-cell mobility serving cell change procedure due to a radio related failure being detected/determined by the wireless device.

Embodiments of the present disclosure may advantageously enable the wireless device to recover from a radio related failure, such as a beam failure or L1/L2 mobility failure, more quickly and with a reduced interruption time, compared to existing recovery procedures, e.g., by executing a L1/L2 based inter-cell mobility serving cell change procedure. Embodiments of the present disclosure, in some cases, may avoid triggering RRC Re-establishment in case the serving cell or target cell is unavailable. It may be the case that despite the failure at the wireless device, Key Performance Indicators (KPIs) at the network would only show L1/L2 inter-cell mobility executions.

According to a first aspect of the present disclosure, a wireless device is configured with a Layer 1/Layer 2 (L1/L2)-based inter-cell mobility configuration for handling radio related failures, the L1/L2-based inter-cell mobility configuration indicating a plurality of candidate target cells and a source cell. The wireless device comprises processing circuitry configured to detect a radio related failure and perform at least one wireless device action based on the L1/L2-based inter-cell mobility configuration and the detected radio related failure.

According to some embodiments of this aspect, the radio related failure comprises at least one of: a beam failure detection (BFD); a failure to execute an L1/L2-based inter-cell mobility serving cell change procedure; a handover failure (HOF); a radio link failure (RLF); and a failure to transmit a maximum number N of radio link control (RLC) protocol data units (PDUs). According to some embodiments of this aspect, the at least one wireless device action comprises: executing a first L1/L2-based inter-cell mobility serving cell change procedure from the source cell to a first candidate target cell of the plurality of candidate target cells. According to some embodiments of this aspect, the at least one wireless device action further comprises: causing transmission, from the wireless device to one of a source network node associated with the source cell, a first target network node associated with the first candidate target cell, and a second target network node associated with a second candidate target cell of the plurality of candidate target cells, of a first indication that the wireless device has executed the L1/L2-based inter-cell mobility serving cell change procedure.

According to some embodiments of this aspect, the at least one wireless device action comprises: causing transmission, to at least one of a source network node associated with the source cell, a first target network node associated with a first candidate target cell of the plurality of candidate target cells, and a second target network node associated with a second candidate target cell of the plurality of candidate target cells, a second indication that the wireless device has detected the radio related failure. The second indication indicates at least one of: a type of the radio related failure; measurement data associated with at least one of the plurality of candidate target cells; and a requested candidate target cell of the plurality of candidate target cells. According to some embodiments of this aspect, the processing circuitry is further configured to: receive, responsive to the second indication, a response from one of the source network node, the first target network node, and the second target network node, a first message; and determine, responsive to the first message, whether to execute an L1/L2-based inter-cell mobility serving cell change procedure to an L1/L2-based inter-cell mobility candidate target cell.

According to some embodiments of this aspect, the processing circuitry is further configured to: receive the L1/L2-based inter-cell mobility configuration from a source network node associated with the source cell, the configuration indicating that the wireless device is permitted to perform the L1/L2-based inter-cell mobility serving cell change procedure when at least one radio related failure has been detected. According to some embodiments of this aspect, the at least one wireless device action comprises: initiating one of a radio resource control (RRC) re-establishment procedure and a condition handover (CHO) procedure; identifying a plurality of available cells; selecting a first cell of the plurality of available cells; and one of: when the first cell is one of the plurality of candidate target cells of the L1/L2-based inter-cell mobility configuration, executing an L1/L2-based inter-cell mobility serving cell change procedure; and when the first cell is not one of the at least one candidate target cells of the L1/L2-based inter-cell mobility configuration, continuing with one of the RRC re-establishment procedure and the CHO procedure by causing transmission of an RRC re-establishment request to the selected cell.

According to some embodiments of this aspect, selecting the first cell comprises: prioritizing selection of the first cell from the plurality of available cells based on at least one of: the first cell being one of the plurality of candidate target cells of the L1/L2-based inter-cell mobility configuration, the first cell being prioritized over any cell of the plurality of available cells which is not one of the plurality of candidate target cells of the L1/L2-based inter-cell mobility configuration; at least one of a reference signal received power (RSRP), a reference signal received quality (RSRQ), and a signal to interference and noise ratio (SINR) of the first cell; and a priority index associated with the first cell. According to some embodiments of this aspect, the radio related failure is one of: a master cell group radio link failure, the plurality of candidate target cells being limited to primary cells; a secondary cell group radio link failure, the plurality of candidate target cells being limited to primary secondary cell group cells; and a secondary cell radio link failure, the plurality of candidate target cells being limited to secondary cells.

According to some embodiments of this aspect, the at least one wireless device action includes: selecting a first target cell of the plurality of candidate target cells to perform an L1/L2-based inter-cell mobility serving cell change procedure: selecting a first beam based on at least one of: the first beam being associated with at least one signal quality metric which is above a first threshold; the first beam being associated with a synchronization signal block (SSB) with at least one signal quality metric above a second threshold; the first beam being associated with the first target cell; and the first beam being configured as a quasi-co-located (QCL) source of a Transmission Configuration Indicator (TCI) state of the first target cell. The at least one action further includes executing the L1/L2-based inter-cell mobility serving cell change procedure to the first cell based on the first beam and causing transmission of a third indication of the selected beam to a target network node associated with the target cell.

According to another aspect of the present disclosure, a method is implemented in a wireless device configured with a Layer 1/Layer 2 (L1/L2)-based inter-cell mobility configuration for handling radio related failures, the L1/L2-based inter-cell mobility configuration indicating a plurality of candidate target cells and a source cell. The method includes detecting a radio related failure and performing at least one wireless device action based on the L1/L2-based inter-cell mobility configuration and the detected radio related failure.

According to some embodiments of this aspect, the radio related failure comprises at least one of: a beam failure detection (BFD); a failure to execute an L1/L2-based inter-cell mobility serving cell change procedure; a handover failure (HOF); a radio link failure (RLF); and a failure to transmit a maximum number N of radio link control (RLC) protocol data units (PDUs). According to some embodiments of this aspect, the at least one wireless device action comprises executing a first L1/L2-based inter-cell mobility serving cell change procedure from the source cell to a first candidate target cell of the plurality of candidate target cells. According to some embodiments of this aspect, the at least one wireless device action further comprises causing transmission, from the wireless device to one of a source network node associated with the source cell, a first target network node associated with the first candidate target cell, and a second target network node associated with a second candidate target cell of the plurality of candidate target cells, of a first indication that the wireless device has executed the L1/L2-based inter-cell mobility serving cell change procedure. According to some embodiments of this aspect, the at least one wireless device action comprises: transmitting, to at least one of a source network node associated with the source cell, a first target network node associated with a first candidate target cell of the plurality of candidate target cells, and a second target network node associated with a second candidate target cell of the plurality of candidate target cells, a second indication that the wireless device has detected the radio related failure. The second indication indicates at least one of: a type of the radio related failure; measurement data associated with at least one of the plurality of candidate target cells; and a requested candidate target cell of the plurality of candidate target cells.

According to some embodiments of this aspect, the method further comprises: receiving, responsive to the second indication, a response from one of the source network node, the first target network node, and the second target network node, a first message; and determining, responsive to the first message, whether to execute an L1/L2-based inter-cell mobility serving cell change procedure to an L1/L2-based inter-cell mobility candidate target cell. According to some embodiments of this aspect, the method further comprises: receiving the L1/L2-based inter-cell mobility configuration from a source network node associated with the source cell, the configuration indicating that the wireless device is permitted to perform the L1/L2-based inter-cell mobility serving cell change procedure when at least one radio related failure has been detected.

According to some embodiments of this aspect, the at least one wireless device action comprises: initiating one of a radio resource control (RRC) re-establishment procedure and a condition handover (CHO) procedure; identifying a plurality of available cells; selecting a first cell of the plurality of available cells; and one of: when the first cell is one of the plurality of candidate target cells of the L1/L2-based inter-cell mobility configuration, executing an L1/L2-based inter-cell mobility serving cell change procedure; and when the first cell is not one of the at least one candidate target cells of the L1/L2-based inter-cell mobility configuration, continuing with one of the RRC re-establishment procedure and the CHO procedure by causing transmission of an RRC re-establishment request to the selected cell.

According to some embodiments of this aspect, wherein selecting the first cell comprises: prioritizing selection of the first cell from the plurality of available cells based on at least one of: the first cell being one of the plurality of candidate target cells of the L1/L2-based inter-cell mobility configuration, the first cell being prioritized over any cell of the plurality of available cells which is not one of the plurality of candidate target cells of the L1/L2-based inter-cell mobility configuration; at least one of a reference signal received power (RSRP), a reference signal received quality (RSRQ), and a signal to interference and noise ratio (SINR) of the first cell; and a priority index associated with the first cell. According to some embodiments of this aspect, the radio related failure is one of: a master cell group radio link failure, the plurality of candidate target cells being limited to primary cells; a secondary cell group radio link failure, the plurality of candidate target cells being limited to primary secondary cell group cells; and a secondary cell radio link failure, the plurality of candidate target cells being limited to secondary cells.

According to some embodiments of this aspect, the at least one wireless device action includes: selecting a first target cell of the plurality of candidate target cells to perform an L1/L2-based inter-cell mobility serving cell change procedure, selecting a first beam based on at least one of: the first beam being associated with at least one signal quality metric which is above a first threshold; the first beam being associated with a synchronization signal block (SSB) with at least one signal quality metric above a second threshold; the first beam being associated with the first target cell; and the first beam being configured as a quasi-co-located (QCL) source of a Transmission Configuration Indicator (TCI) state of the first target cell. The at least one wireless device action further includes executing the L1/L2-based inter-cell mobility serving cell change procedure to the first cell based on the first beam and transmitting a third indication of the selected beam to a target network node associated with the target cell.

According to another aspect of the present disclosure, a source network node is configured to communicate with a wireless device. The source network node comprises processing circuitry configured to configure the wireless device with a configuration for the wireless device to handle a radio related failure, the configuration indicating at least one target candidate cell for inter-cell mobility switching, the configuration configuring an execution of a Layer 1/Layer 2 (L1/L2)-based inter-cell mobility serving cell change procedure after the radio related failure is detected by the wireless device, and perform at least one network node action based on the configuration.

According to some embodiments of this aspect, the processing circuitry is further configured to receive a first indication from one of a target network node and a third network node, the first indication indicating that the wireless device has executed the L1/L2-based inter-cell mobility serving cell change procedure based on the configuration. According to some embodiments of this aspect, the first indication indicates a radio related failure was detected by the wireless device. According to some embodiments of this aspect, the performing of the at least one network node action includes causing transmission, to a source central unit (CU), of a second indication that the wireless device has executed the L1/L2-based inter-cell mobility serving cell procedure. According to some embodiments of this aspect, the processing circuitry is further configured to: receive a third indication, from the wireless device, of a detected radio related failure, the third indication indicating that the wireless device failed to execute the L1/L2-based inter-cell mobility serving cell change procedure on a first target cell; and in response to receiving the third indication, cause transmission, to the wireless device, of a request for the wireless device to execute an L1/L2-based inter-cell mobility serving cell change procedure for a different target cell than the first target cell.

According to another aspect of the present disclosure, a method is implemented in a source network node configured to communicate with a wireless device. The method comprises configuring the wireless device with a configuration for the wireless device to handle a radio related failure, the configuration indicating at least one target candidate cell for inter-cell mobility switching, the configuration configuring an execution of a Layer 1/Layer 2 (L1/L2)-based inter-cell mobility serving cell change procedure after the radio related failure is detected by the wireless device, and performing at least one network node action based on the configuration.

According to some embodiments of this aspect, the method further comprises receiving a first indication from one of a target network node and a third network node, the first indication indicating that the wireless device has executed the L1/L2-based inter-cell mobility serving cell change procedure based on the configuration. According to some embodiments of this aspect, the first indication indicates a radio related failure was detected by the wireless device. According to some embodiments of this aspect, the performing of the at least one network node action includes transmitting, to a source central unit (CU), a second indication that the wireless device has executed the L1/L2-based inter-cell mobility serving cell procedure. According to some embodiments of this aspect, the method further comprises: receiving a third indication, from the wireless device, of a detected radio related failure, the third indication indicating that the wireless device failed to execute the L1/L2-based inter-cell mobility serving cell change procedure on a first target cell; and in response to receiving the third indication, transmitting, to the wireless device, a request for the wireless device to execute an L1/L2-based inter-cell mobility serving cell change procedure for a different target cell than the first target cell.

According to another aspect of the present disclosure, a serving network node is configured to communicate with a wireless device. The serving network node comprises processing circuitry configured to determine a configuration of an L1/L2-based inter-cell mobility candidate target cell, the configuration including a first indication indicating at least one target candidate cell, and cause transmission, to at least one of a source network node and the wireless device, of the configuration.

According to some embodiments of this aspect, the first indication indicates an execution of an inter-cell mobility serving cell change procedure after a radio related failure is detected by the wireless device. According to some embodiments of this aspect, the serving network node is at least one of a Central Unit (CU) and a serving gNB-CU. According to some embodiments of this aspect, the first indication is one of: common for a plurality of L1/L2-based inter-cell mobility candidate cells; and is specific for a first L1/L2-based inter-cell mobility candidate cell.

According to some embodiments of this aspect, the serving network node is further configured to at least one of: receive, from one of a first target network node and a second target network node, a second indication that the wireless device has executed the L1/L2-based inter-cell mobility serving cell change procedure; and cause transmission, to a source network node, of a third indication that the wireless device has executed the L1/L2-based inter-cell mobility serving cell change procedure. According to some embodiments of this aspect, at least one of the second indication and the third indication indicates that a radio related failure was detected by the wireless device.

According to another aspect of the present disclosure, a method is implemented in a serving network node configured to communicate with a wireless device. The method comprises determining a configuration of an L1/L2-based inter-cell mobility candidate target cell, the configuration including a first indication indicating at least one target candidate cell, and transmitting, to at least one of a source network node and the wireless device, the configuration. According to some embodiments of this aspect, the first indication indicates an execution of an inter-cell mobility serving cell change procedure after a radio related failure is detected by the wireless device. According to some embodiments of this aspect, the serving network node is at least one of a Central Unit (CU) and a serving gNB-CU. According to some embodiments of this aspect, the first indication is one of: common for a plurality of L1/L2-based inter-cell mobility candidate cells; and is specific for a first L1/L2-based inter-cell mobility candidate cell. According to some embodiments of this aspect, method further comprises at least one of: receiving, from one of a first target network node and a second target network node, a second indication that the wireless device has executed the L1/L2-based inter-cell mobility serving cell change procedure; and transmitting, to a source network node, a third indication that the wireless device has executed the L1/L2-based inter-cell mobility serving cell change procedure. According to some embodiments of this aspect, at least one of the second indication and the third indication indicates that a radio related failure was detected by the wireless device.

According to another aspect of the present disclosure, a first target network node is configured to communicate with a wireless device. The first target network node comprises processing circuitry configured to: receive, from the wireless device, a first indication indicating that the wireless device has executed an L1/L2-based inter-cell mobility serving cell change procedure responsive to the wireless device detecting a radio link failure, and perform at least one network node action based on the receiving of the first indication.

According to some embodiments of this aspect, the first target network node is at least one of a target gNB, a target distributed unit (DU), and a target central unit (CU). According to some embodiments of this aspect, the performing of the at least one network node action includes causing transmission, to one of a source network node and a third network node, of a second indication that the wireless device has executed the L1/L2-based inter-cell mobility serving cell change procedure. According to some embodiments of this aspect, the processing circuitry is further configured to receive, from a third network node, a third indication that the wireless device has executed the L1/L2-based inter-cell mobility serving cell change procedure.

According to some embodiments of this aspect, at least one of the first indication, the second indication, and the third indication indicates that a radio related failure was detected by the wireless device. According to some embodiments of this aspect, the processing circuitry is further configured to configure the wireless device with a configuration of an L1/L2-based inter-cell mobility candidate target cell including an indication that the wireless device is allowed to perform the L1/L2-based inter-cell mobility serving cell change procedure with at least one candidate target cell when the wireless device detects a radio related failure.

According to another aspect of the present disclosure, a method implemented in a first target network node configured to communicate with a wireless device is provided. The method comprises receiving, from the wireless device, a first indication indicating that the wireless device has executed an L1/L2-based inter-cell mobility serving cell change procedure responsive to the wireless device detecting a radio link failure, and performing at least one network node action based on the receiving of the first indication.

According to some embodiments of this aspect, the first target network node is at least one of a target gNB, a target distributed unit (DU), and a target central unit (CU). According to some embodiments of this aspect, the performing of the at least one network node action includes transmitting, to one of a source network node and a third network node, of a second indication that the wireless device has executed the L1/L2-based inter-cell mobility serving cell change procedure. According to some embodiments of this aspect, the method further comprises receiving, from a third network node, a third indication that the wireless device has executed the L1/L2-based inter-cell mobility serving cell change procedure. According to some embodiments of this aspect, at least one of the first indication, the second indication, and the third indication indicates that a radio related failure was detected by the wireless device. According to some embodiments of this aspect, the method further comprises configuring the wireless device with a configuration of an L1/L2-based inter-cell mobility candidate target cell including an indication that the wireless device is allowed to perform the L1/L2-based inter-cell mobility serving cell change procedure with at least one candidate target cell when the wireless device detects a radio related failure.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a wireless device for failure handling during L1/L2 Mobility according to some embodiments of the present disclosure;

FIG. 8 is a flowchart of an example process in a source network node for failure handling during L1/L2 Mobility according to some embodiments of the present disclosure;

FIG. 9 is a flowchart of an example process in a serving network node for failure handling during L1/L2 Mobility according to some embodiments of the present disclosure;

FIG. 10 is a flowchart of an example process in a first target network node for failure handling during L1/L2 Mobility according to some embodiments of the present disclosure;

FIG. 11 is a flowchart of an example process in a second target network node for failure handling during L1/L2 Mobility according to some embodiments of the present disclosure;

FIG. 12 is a flowchart of another example process in a wireless device for failure handling during L1/L2 Mobility according to some embodiments of the present disclosure;

FIG. 13 is a flowchart of another example process in a source network node for failure handling during L1/L2 Mobility according to some embodiments of the present disclosure;

FIG. 14 is a flowchart of another example process in a serving network node for failure handling during L1/L2 Mobility according to some embodiments of the present disclosure;

FIG. 15 is a flowchart of another example process in a first target network node for failure handling during L1/L2 Mobility according to some embodiments of the present disclosure;

FIG. 16 illustrates an example system architecture corresponding to some embodiments of the present disclosure;

FIG. 17 is an example message sequence chart according to some embodiments of the present disclosure;

FIG. 18 is another example message sequence chart according to some embodiments of the present disclosure;

FIG. 19 is another example message sequence chart according to some embodiments of the present disclosure;

FIG. 20 is another example message sequence chart according to some embodiments of the present disclosure;

FIG. 21 is another example message sequence chart according to some embodiments of the present disclosure;

FIG. 22 is another example message sequence chart according to some embodiments of the present disclosure;

FIG. 23 is another example message sequence chart according to some embodiments of the present disclosure;

FIG. 24 is another example message sequence chart according to some embodiments of the present disclosure; and

FIG. 25 is a flowchart of another example process in a wireless device according to some embodiments of the present disclosure.

### DETAILED DESCRIPTION

Before describing in detail example embodiments, it is noted that the embodiments reside primarily in combinations of apparatus components and processing steps related to failure handling during L1/L2 Mobility. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In the general sense, in one or more embodiments, L1 can be considered the physical (PHY) layer and L2 can be considered the media access control (MAC) layer. Some embodiments of the present disclosure refer to L1/L2 based inter-cell mobility, which may, for example, refer to the wireless device receiving a L1 and/or L2 signaling (e.g., instead of radio resource control (RRC) signaling) indicating a transmission configuration indicator (TCI) state (e.g., for physical downlink control channel (PDCCH)), and possibly associated to an synchronization signal block (SSB) whose Physical Channel Indicator (PCI) is not necessarily the same as the PCI of the cell the wireless device has connected to, e.g. via connection resume or connection establishment. In some example embodiments, L1/L2 based inter-cell mobility may be, by default, based on L1 channel state information (CSI)-measurements. Further, the term “L1/L2 inter-cell centric mobility” may be used interchangeably with the terms L1/L2 mobility, L1-mobility, L1/L2-centric mobility, etc. In some example embodiments, L1/L2 centric mobility may refers to a wireless device in a connected/active state, e.g., RRC_CONNECTED, being connected (i.e., being served by) to at least one serving cell/serving network node, considered to be the Primary Cell (PCell), or a set of serving cells/serving network nodes. The wireless device may be configured with multiple PCIs (e.g., PCI-2, PCI-3, PCI-4), wherein each PCI, or equivalently stated, any SSB beam related to the PCI, can be used as a QCL source in a TCI state with which the wireless device is configured. As used herein PCI and TRP may sometimes be used interchangeably.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide methods, apparatuses, and/or systems for failure handling during L1/L2 Mobility.

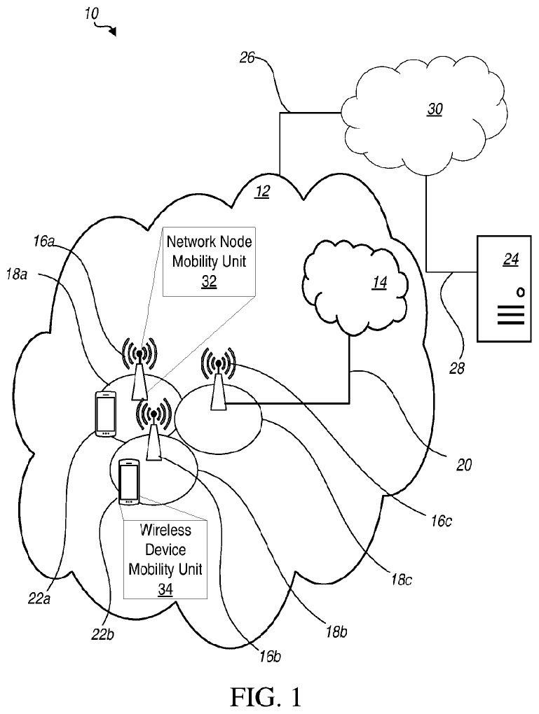

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18) (“coverage area” is also referred to as “cell” herein). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a Network Node Mobility Unit 32 which is configured for failure handling during L1/L2 Mobility. A wireless device 22 is configured to include a Wireless Device Mobility Unit 34 which is configured for failure handling during L1/L2 Mobility.

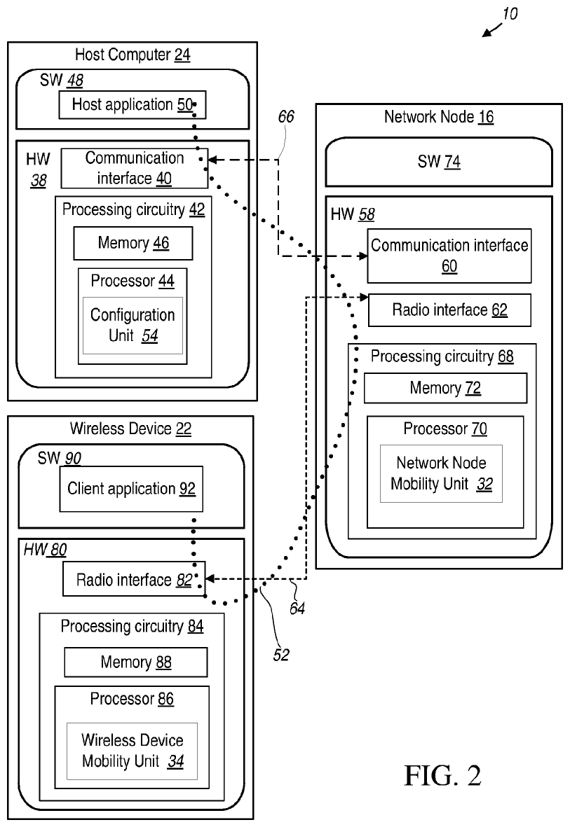

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a Configuration Unit 54 configured to enable the service provider to observe/monitor/control/transmit to/receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include Network Node Mobility Unit 32 configured for failure handling during L1/L2 Mobility.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a Wireless Device Mobility Unit 34 configured for failure handling during L1/L2 Mobility.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as Network Node Mobility Unit 32 and Wireless Device Mobility Unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

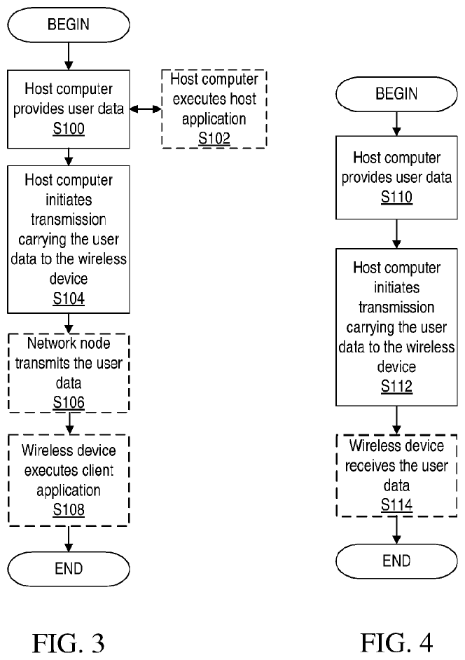

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

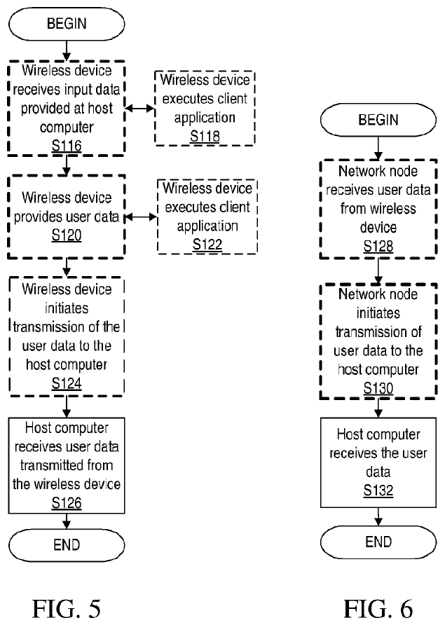

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

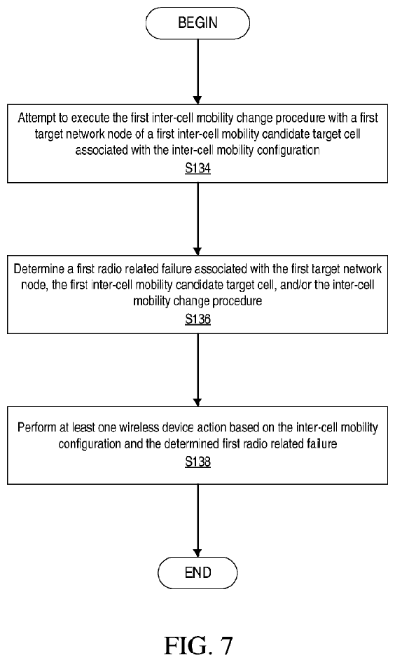

FIG. 7 is a flowchart of an example process in a wireless device 22 according to some embodiments of the present disclosure for failure handling during L1/L2 Mobility. One or more blocks described herein may be performed by one or more elements of wireless device 22 such as by one or more of processing circuitry 84 (including the Wireless Device Mobility Unit 34), processor 86, radio interface 82 and/or communication interface 60. Wireless device 22 is configured with an inter-cell mobility configuration for handling radio related failures. The wireless device 22 is configured to attempt to execute (Block S134) the first inter-cell mobility change procedure with a first target network node 16 of a first inter-cell mobility candidate target cell 18 associated with the inter-cell mobility configuration. The wireless device 22 is further configured to determine (Block S136) a first radio related failure associated with the first target network node 16, the first inter-cell mobility candidate target cell 18, and/or the inter-cell mobility change procedure. The wireless device 22 is further configured to perform (Block S138) at least one wireless device action based on the inter-cell mobility configuration and the determined first radio related failure.

In some embodiments, the wireless device 22 is further configured to receive a first lower layer signal from a source network node 16 requesting execution of a first inter-cell mobility change procedure. The attempting to execute the first inter-cell mobility change procedure is based on the receiving of the first lower layer signal.

In some embodiments, the first lower layer signal from the source network node 16 indicates at least one of the first target network node 16 and the first inter-cell mobility candidate target cell 18.

In some embodiments, the wireless device 22 is further configured to detect a source cell radio related failure of a source cell 18 associated with the source network node 16, where the attempting to execute the first inter-cell mobility change procedure is based on the detecting of the source cell radio related failure.

In some embodiments, the first radio related failure is at least one of a beam failure detection (BFD), a failure to execute the first inter-cell mobility serving cell change procedure, a handover failure (HOF) and/or an expiration of a timer associated with the HOF, a radio link failure (RLF) and/or an expiration of a timer associated with the RLF, and a failure to transmit a maximum number N of Radio Link Control (RLC) Protocol Data Units (PDU).

In some embodiments, the performing of the at least one wireless device action includes determining a second inter-cell mobility target cell 18 associated with the inter-cell mobility configuration, and causing transmission of a second indication of the first radio related failure to a second target network node 16 associated with the second inter-cell mobility target cell 18.

In some embodiments, the second indication includes at least one of a type of the first radio related failure, a most recent available measurement on the first inter-cell mobility candidate target cell 18, and a request for a best inter-cell mobility candidate target cell 18 at a time of the radio related failure being determined.

In some embodiments, the performing of the at least one wireless device 22 action includes causing transmission, to the source network node 16, of a third indication of the first radio related failure, receiving, from the source network node 16, in response to the third indication, a fourth indication indicating a second inter-cell mobility candidate target cell 18, and attempting to execute a second first inter-cell mobility change procedure with the second inter-cell mobility candidate target cell 18 based on the third indication.

In some embodiments, the wireless device 22 is configured with a plurality of inter-cell mobility candidate target cells 18 and a cell selection procedure. The performing of the at least one wireless device action includes determining a second target cell 18 based on the cell selection procedure. Optionally, a fifth indication is transmitted to a second target network node 16 associated with the second target cell 18 indicating the radio related failure. Optionally, in response to the transmission of the fifth indication, a sixth indication is received from the second target network node 16 indicating the wireless device 22 is permitted to execute the inter-cell mobility serving cell change procedure to the second target cell 18. The wireless device 22 attempts to execute a second inter-cell mobility change procedure with the determined second target cell 18.

In some embodiments, the cell selection procedure includes at least one of prioritizing a candidate cell 18 which is one of plurality of inter-cell mobility candidate target cells 18 over another cell 18 which is not one of the plurality of inter-cell mobility candidate target cells 18, prioritizing a candidate cell 18 which has a higher signal quality metric, where the metric is at least one of Reference signal received power (RSRP), Reference Signal Received Quality (RSRQ), and/or Signal to Interference and Noise Ratio (SINR), and prioritizing a candidate cell 18 which is one of the plurality of inter-cell mobility candidate target cells 18 over another cell 18 which is a Condition Handover (CHO) candidate cell 18.

In some embodiments, the performing of the at least one wireless device 22 action includes determining a beam, where the determined beam is at least one of associated with a synchronization signal block (SSB) with at least one signal quality metric above a configured threshold, one of a plurality of available beams, the determined beam having the highest signal quality metric of the plurality of available beams, associated to the inter-cell mobility candidate target cell 18, and configured as a quasi-co-located (QCL) source of a Transmission Configuration Indicator (TCI) state of the inter-cell mobility candidate target cell 18. The executing of the second inter-cell mobility serving cell change procedure is based on the determined beam. A sixth indication of the selected beam is transmitted to the target cell 18.

In some embodiments, the configuration of the inter-cell mobility candidate target cell 18 is a Layer (L1)/Layer (L2) based inter-cell mobility configuration which utilizes L1/L2 signaling.

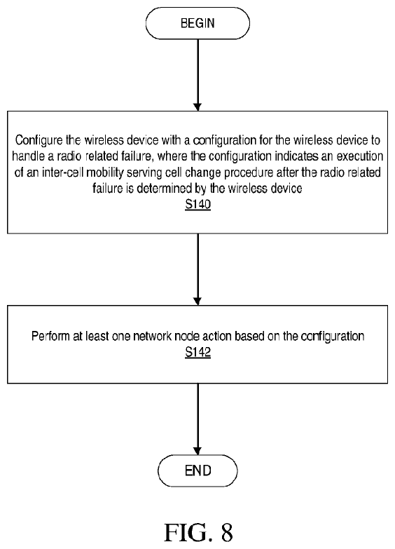

In some embodiments, the inter-cell mobility serving cell change procedure is a L1/L2 based inter-cell mobility serving cell change procedure which utilizes L1/L2 signaling. FIG. 8 is a flowchart of an example process in a network node 16 for failure handling during L1/L2 Mobility. One or more blocks described herein may be performed by one or more elements of network node 16 such as by one or more of processing circuitry 68 (including the Network Node Mobility Unit 32), processor 70, radio interface 62 and/or communication interface 60. Network node 16, which may be a source network node 16, such as a source distributed unit (DU) for the wireless device 22, is configured to configure (Block S140) the wireless device 22 with a configuration for the wireless device 22 to handle a radio related failure, where the configuration indicates an execution of an inter-cell mobility serving cell change procedure after the radio related failure is determined by the wireless device 22. Source network node 16 is further configured to perform (Block S142) at least one network node action based on the configuration.

In some embodiments, the source network node 16 is further configured to receive an indication from one of a target network node 16 and a third network node 16, the indication indicating that the wireless device 22 has executed the inter-cell mobility serving cell change procedure based on the configuration.

In some embodiments, the indication indicates a radio related failure was determined by the wireless device 22.

In some embodiments, the performing of the at least one network node action includes causing transmission, to a source central unit (CU), of an indication that the wireless device 22 has executed the inter-cell mobility serving cell procedure.

In some embodiments, the source network node 16 is further configured to receive an indication, from the wireless device 22, of a determined radio related failure, where the indication indicates that the wireless device 22 failed to execute the inter-cell mobility serving cell change procedure on a first target cell 18. In response to receiving the indication, a request for the wireless device 22 to execute an inter-cell mobility serving cell change procedure for a different target cell 18 is transmitted to the wireless device 22.

In some embodiments, the configuration of the inter-cell mobility candidate target cell 18 is a Layer (L1)/Layer (L2) based inter-cell mobility configuration which utilizes L1/L2 signaling, and the inter-cell mobility serving cell change procedure is a L1/L2 based inter-cell mobility serving cell change procedure which utilizes L1/L2 signaling.

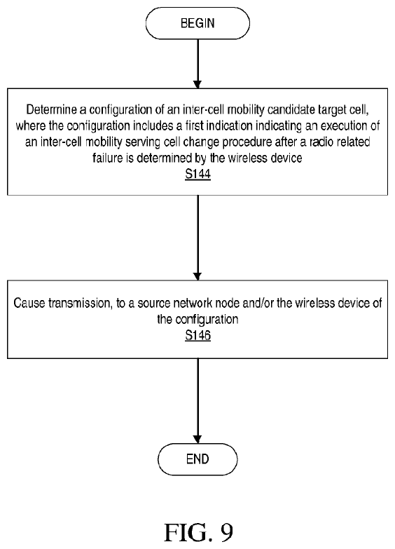

FIG. 9 is a flowchart of another example process in a network node 16 for failure handling during L1/L2 Mobility. One or more blocks described herein may be performed by one or more elements of network node 16 such as by one or more of processing circuitry 68 (including the Network Node Mobility Unit 32), processor 70, radio interface 62 and/or communication interface 60. Network node 16, which may be a serving network node 16, is configured to determine (Block S144) a configuration of an inter-cell mobility candidate target cell 18, where the configuration includes a first indication indicating an execution of an inter-cell mobility serving cell change procedure after a radio related failure is determined by the wireless device 22. The serving network node 16 is further configured to cause transmission (Block S146), to a source network node 16 and/or the wireless device 22, of the configuration.

In some embodiments, the serving network node 16 is a Central Unit (CU) and/or a serving gNB-CU. In some embodiments, the first indication is one of common for a plurality of inter-cell mobility candidate cells 18, and is specific for an inter-cell mobility candidate cell 18.

In some embodiments, the serving network node 16 is further configured to at least one of receive, from a first target network node 16 or a second target network node 16, a second indication that the wireless device 22 has executed the inter-cell mobility serving cell change procedure, and to cause transmission, to a source network node 16, of a third indication that the wireless device 22 has executed the inter-cell mobility serving cell change procedure.

In some embodiments, at least one of the second indication and the third indication indicates that a radio related failure was determined by the wireless device 22.

In some embodiments, the configuration of the inter-cell mobility candidate target cell 18 is a Layer (L1)/Layer (L2) based inter-cell mobility configuration which utilizes L1/L2 signaling, and the inter-cell mobility serving cell change procedure is a L1/L2 based inter-cell mobility serving cell change procedure which utilizes L1/L2 signaling

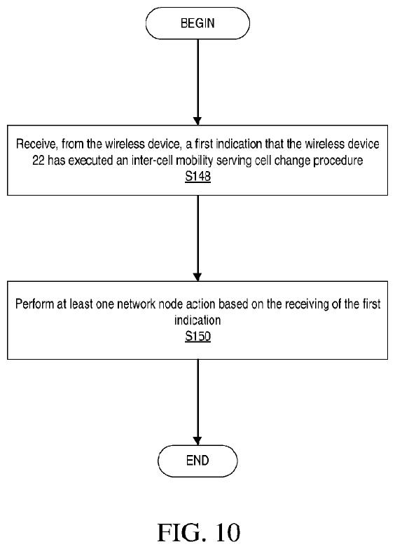

FIG. 10 is a flowchart of another example process in a network node 16 for failure handling during L1/L2 Mobility. One or more blocks described herein may be performed by one or more elements of network node 16 such as by one or more of processing circuitry 68 (including the Network Node Mobility Unit 32), processor 70, radio interface 62 and/or communication interface 60. Network node 16, which may be a first target network node 16, such as a first target distributed unit (DU) of a first target cell 18, is configured to receive (Block S148), from the wireless device 22, a first indication that the wireless device 22 has executed an inter-cell mobility serving cell change procedure. The first target network node 16 is configured to perform (Block S150) at least one network node action based on the receiving of the first indication.

In some embodiments, the first target network node 16 is at least one of a target gNB, a target distributed unit (DU), and a target central unit (CU).

In some embodiments, the performing of the at least one network node action includes causing transmission, to a source network node 16 or a serving network node 16, of a second indication that the wireless device 22 has executed the inter-cell mobility serving cell change procedure.

In some embodiments, the first target network node 16 receives, from a serving network node 16, a third indication that the wireless device 22 has executed the inter-cell mobility serving cell change procedure.

In some embodiments, at least one of the first indication, the second indication, and the third indication indicates that a radio related failure was determined by the wireless device 22.

In some embodiments, the first target network node 16 is configured and/or configured the wireless device 22 with a configuration of an inter-cell mobility candidate target cell 18 including an indication that the wireless device 22 is allowed to perform the inter-cell mobility serving cell change procedure of at least one candidate target cell 18 when the wireless device 22 determines a radio related failure.

In some embodiments, the configuration of the inter-cell mobility candidate target cell 18 is a Layer (L1)/Layer (L2) based inter-cell mobility configuration which utilizes L1/L2 signaling.

In some embodiments, the first target network node 16 of any one of Embodiments L1-L7, wherein the inter-cell mobility serving cell change procedure is a L1/L2 based inter-cell mobility serving cell change procedure which utilizes L1/L2 signaling.

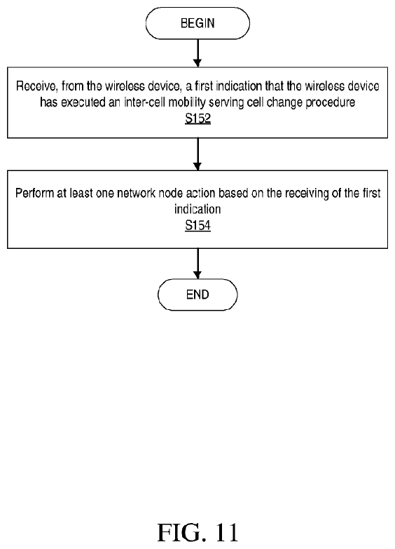

FIG. 11 is a flowchart of another example process in a network node 16 for failure handling during L1/L2 Mobility. One or more blocks described herein may be performed by one or more elements of network node 16 such as by one or more of processing circuitry 68 (including the Network Node Mobility Unit 32), processor 70, radio interface 62 and/or communication interface 60. Network node 16, which may be a second target network node 16, such as a second target distributed unit (DU) of a second target cell 18, for the wireless device 22, is configured to receive (Block S152), from the wireless device 22, a first indication that the wireless device 22 has executed an inter-cell mobility serving cell change procedure. The second target network node 16 is configured to perform (Block S154) at least one network node action based on the receiving of the first indication.

In some embodiments, the second target network node 16 is at least one of a target gNB, a target distributed unit (DU), and a target central unit (CU).

In some embodiments, the performing of the at least one network node action includes causing transmission, to a source network node 16 or a third network node 16, of a second indication that the wireless device 22 has executed the inter-cell mobility serving cell change procedure.

In some embodiments, the second target network node 16 receives, from a serving network node 16, a third indication that the wireless device 22 has executed the inter-cell mobility serving cell change procedure.

In some embodiments, at least one of the first indication, the second indication, and the third indication indicates that a radio related failure was determined by the wireless device 22.

In some embodiments, the second target network node 16 is configured and/or configured the wireless device 22 with a configuration of an inter-cell mobility candidate target cell 18 including an indication that the wireless device 22 is allowed to perform the inter-cell mobility serving cell change procedure of at least one candidate target cell 18 when the wireless device 22 determines a radio related failure.

In some embodiments, the configuration of the inter-cell mobility candidate target cell 18 is a Layer (L1)/Layer (L2) based inter-cell mobility configuration which utilizes L1/L2 signaling.

In some embodiments, the inter-cell mobility serving cell change procedure is a L1/L2 based inter-cell mobility serving cell change procedure which utilizes L1/L2 signaling.

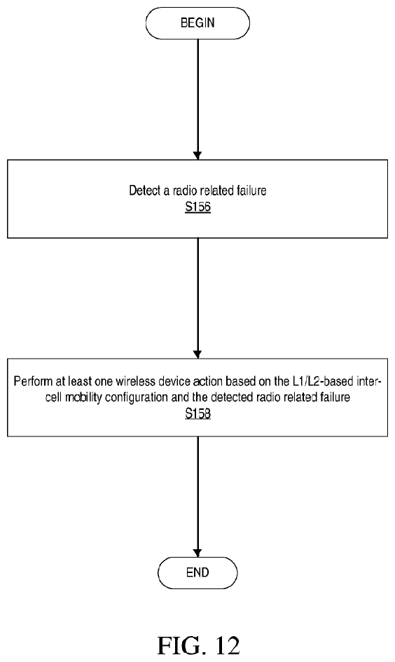

FIG. 12 is a flowchart of another example process in a wireless device 22 according to some embodiments of the present disclosure for failure handling during L1/L2 Mobility. One or more blocks described herein may be performed by one or more elements of wireless device 22 such as by one or more of processing circuitry 84 (including the Wireless Device Mobility Unit 34), processor 86, radio interface 82 and/or communication interface 60. Wireless device 22 is configured with an inter-cell mobility configuration for handling radio related failures. The wireless device 22 is configured with a Layer 1/Layer 2 (L1/L2)-based inter-cell mobility configuration for handling radio related failures, the L1/L2-based inter-cell mobility configuration indicating a plurality of candidate target cells 18 and a source cell 18. The wireless device is configured to detect (Block S156) a radio related failure and perform (Block S158) at least one wireless device action based on the L1/L2-based inter-cell mobility configuration and the detected radio related failure.

In some embodiments, the radio related failure comprises at least one of: a beam failure detection (BFD); a failure to execute an L1/L2-based inter-cell mobility serving cell change procedure; a handover failure (HOF); a radio link failure (RLF); and a failure to transmit a maximum number N of radio link control (RLC) protocol data units (PDUs). In some embodiments the at least one wireless device action comprises: executing a first L1/L2-based inter-cell mobility serving cell change procedure from the source cell 18 to a first candidate target cell 18 of the plurality of candidate target cells 18. In some embodiments, the at least one wireless device action further comprises causing transmission, from the wireless device 22 to one of a source network node 16 associated with the source cell 18, a first target network node 16 associated with the first candidate target cell 18, and a second target network node 16 associated with a second candidate target cell 18 of the plurality of candidate target cells 18, of a first indication that the wireless device 22 has executed the L1/L2-based inter-cell mobility serving cell change procedure. In some embodiments, the at least one wireless device action comprises: causing transmission, to at least one of a source network node 16 associated with the source cell 18, a first target network node 16 associated with a first candidate target cell of the plurality of candidate target cells 18, and a second target network node 16 associated with a second candidate target cell of the plurality of candidate target cells 18, a second indication that the wireless device 22 has detected the radio related failure. The second indication indicates at least one of: a type of the radio related failure; measurement data associated with at least one of the plurality of candidate target cells 18; and a requested candidate target cell 18 of the plurality of candidate target cells 18.

In some embodiments, the processing circuitry 84 is further configured to: receive, responsive to the second indication, a response from one of the source network node 16, the first target network node 16, and the second target network node 16, a first message; and determine, responsive to the first message, whether to execute an L1/L2-based inter-cell mobility serving cell change procedure to an L1/L2-based inter-cell mobility candidate target cell 18.

In some embodiments, the processing circuitry 84 is further configured to receive the L1/L2-based inter-cell mobility configuration from a source network node 16 associated with the source cell 18, the configuration indicating that the wireless device 22 is permitted to perform the L1/L2-based inter-cell mobility serving cell change procedure when at least one radio related failure has been detected. In some embodiments, the at least one wireless device action comprises: initiating one of a radio resource control (RRC) re-establishment procedure and a condition handover (CHO) procedure; identifying a plurality of available cells 18;

selecting a first cell 18 of the plurality of available cells 18; and one of: when the first cell 18 is one of the plurality of candidate target cells 18 of the L1/L2-based inter-cell mobility configuration, executing an L1/L2-based inter-cell mobility serving cell change procedure; and when the first cell 18 is not one of the at least one candidate target cells 18 of the L1/L2-based inter-cell mobility configuration, continuing with one of the RRC re-establishment procedure and the CHO procedure by causing transmission of an RRC re-establishment request to the selected cell 18.

In some embodiments, selecting the first cell 18 comprises prioritizing selection of the first cell from the plurality of available cells 18 based on at least one of: the first cell 18 being one of the plurality of candidate target cells 18 of the L1/L2-based inter-cell mobility configuration, the first cell 18 being prioritized over any cell 18 of the plurality of available cells 18 which is not one of the plurality of candidate target cells 18 of the L1/L2-based inter-cell mobility configuration; at least one of a reference signal received power (RSRP), a reference signal received quality (RSRQ), and a signal to interference and noise ratio (SINR) of the first cell 18; and a priority index associated with the first cell 18.

In some embodiments, the radio related failure is one of: a master cell group radio link failure, the plurality of candidate target cells 18 being limited to primary cells 18; a secondary cell group radio link failure, the plurality of candidate target cells 18 being limited to primary secondary cell group cells 18; and a secondary cell radio link failure, the plurality of candidate target cells 18 being limited to secondary cells.

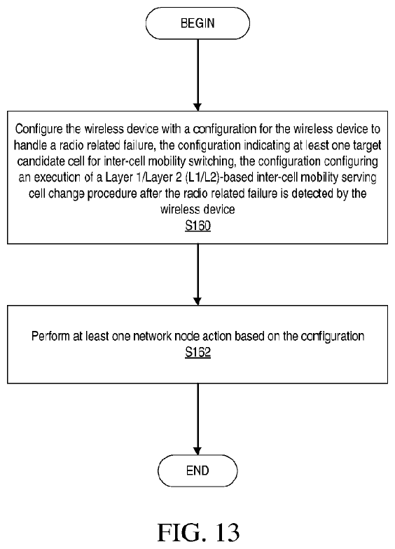

In some embodiments, the at least one wireless device action includes: selecting a first target cell 18 of the plurality of candidate target cells 18 to perform an L1/L2-based inter-cell mobility serving cell change procedure; and selecting a first beam based on at least one of: the first beam being associated with at least one signal quality metric which is above a first threshold; the first beam being associated with a synchronization signal block (SSB) with at least one signal quality metric above a second threshold; the first beam being associated with the first target cell 18; and the first beam being configured as a quasi-co-located (QCL) source of a Transmission Configuration Indicator (TCI) state of the first target cell 18. The selecting of the first target cell 18 further incudes executing the L1/L2-based inter-cell mobility serving cell change procedure to the first cell based on the first beam and causing transmission of a third indication of the selected beam to a target network node 16 associated with the target cell 18. FIG. 13 is a flowchart of another example process in a network node 16 (e.g., a source network node 16) for failure handling during L1/L2 Mobility. One or more blocks described herein may be performed by one or more elements of network node 16 such as by one or more of processing circuitry 68 (including the Network Node Mobility Unit 32), processor 70, radio interface 62 and/or communication interface 60. Network node 16, which may be a source network node 16, such as a source distributed unit (DU) for the wireless device 22, is configured to configure (Block S160) the wireless device 22 with a configuration for the wireless device 22 to handle a radio related failure, the configuration indicating at least one target candidate cell 18 for inter-cell mobility switching, the configuration configuring an execution of a Layer 1/Layer 2 (L1/L2)-based inter-cell mobility serving cell change procedure after the radio related failure is detected by the wireless device 22, and perform (Block S162) at least one network node action based on the configuration.

In some embodiments, the processing circuitry 68 is further configured to receive a first indication from one of a target network node 16 and a third network node 16, the first indication indicating that the wireless device 22 has executed the L1/L2-based inter-cell mobility serving cell change procedure based on the configuration. In some embodiments, the first indication indicates a radio related failure was detected by the wireless device 22. In some embodiments, the performing of the at least one network node action includes causing transmission, to a source central unit (CU), of a second indication that the wireless device 22 has executed the L1/L2-based inter-cell mobility serving cell procedure. In some embodiments, the processing circuitry 68 is further configured to receive a third indication, from the wireless device 22, of a detected radio related failure, the third indication indicating that the wireless device 22 failed to execute the L1/L2-based inter-cell mobility serving cell change procedure on a first target cell 18; and in response to receiving the third indication, cause transmission, to the wireless device 22, of a request for the wireless device 22 to execute an L1/L2-based inter-cell mobility serving cell change procedure for a different target cell 18 than the first target cell 18.

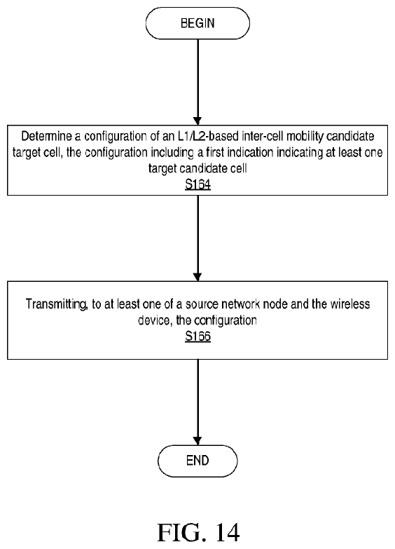

FIG. 14 is a flowchart of another example process in a network node 16 (e.g., a serving network node 16) for failure handling during L1/L2 Mobility. One or more blocks described herein may be performed by one or more elements of network node 16 such as by one or more of processing circuitry 68 (including the Network Node Mobility Unit 32), processor 70, radio interface 62 and/or communication interface 60. Network node 16, which may be a serving network node 16, is configured to determine (Block S164) a configuration of an L1/L2-based inter-cell mobility candidate target cell, the configuration including a first indication indicating at least one target candidate cell 18, and transmit (Block S166), to at least one of a source network node 16 and the wireless device 22, the configuration.

In some embodiments, the first indication indicates an execution of an inter-cell mobility serving cell change procedure after a radio related failure is detected by the wireless device 22.

In some embodiments, the serving network node 16 is at least one of a Central Unit (CU) and a serving gNB-CU. In some embodiments, the first indication is one of common for a plurality of L1/L2-based inter-cell mobility candidate cells 18 and is specific for a first L1/L2-based inter-cell mobility candidate cell 18. In some embodiments, the serving network node 16 is further configured to at least one of receive, from one of a first target network node 16 and a second target network node 16, a second indication that the wireless device 22 has executed the L1/L2-based inter-cell mobility serving cell change procedure, and cause transmission, to a source network node 16, of a third indication that the wireless device 22 has executed the L1/L2-based inter-cell mobility serving cell change procedure. In some embodiments, at least one of the second indication and the third indication indicates that a radio related failure was detected by the wireless device 22.

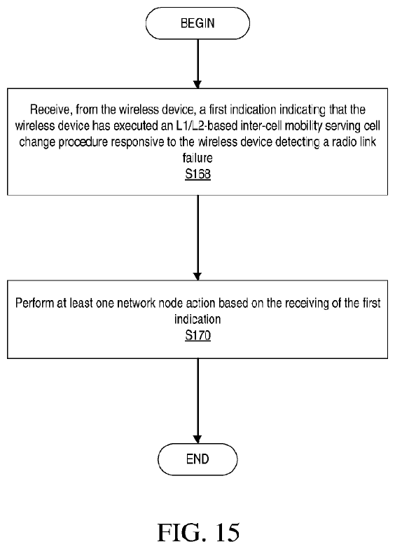

FIG. 15 is a flowchart of another example process in a network node 16 for failure handling during L1/L2 Mobility. One or more blocks described herein may be performed by one or more elements of network node 16 such as by one or more of processing circuitry 68 (including the Network Node Mobility Unit 32, processor 70, radio interface 62 and/or communication interface 60. Network node 16, which may be a first target network node 16, such as a first target distributed unit (DU) of a first target cell 18, is configured to receive (Block S168), from the wireless device 22, a first indication indicating that the wireless device 22 has executed an L1/L2-based inter-cell mobility serving cell change procedure responsive to the wireless device 22 detecting a radio link failure, and perform (Block S170) at least one network node action based on the receiving of the first indication.

In some embodiments, the first target network node 16 is at least one of a target gNB, a target distributed unit (DU), and a target central unit (CU). In some embodiments, the performing of the at least one network node action includes causing transmission, to one of a source network node 16 and a third network node 16, of a second indication that the wireless device 22 has executed the L1/L2-based inter-cell mobility serving cell change procedure. In some embodiments, the processing circuitry 68 is further configured to receive, from a third network node 16, a third indication that the wireless device 22 has executed the L1/L2-based inter-cell mobility serving cell change procedure. In some embodiments, at least one of the first indication, the second indication, and the third indication indicates that a radio related failure was detected by the wireless device 22.

In some embodiments, the processing circuitry 68 is further configured to configure the wireless device 22 with a configuration of an L1/L2-based inter-cell mobility candidate target cell 18 including an indication that the wireless device 22 is allowed to perform the L1/L2-based inter-cell mobility serving cell change procedure with at least one candidate target cell 18 when the wireless device 22 detects a radio related failure.

Having described the general process flow of arrangements of the disclosure and having provided examples of hardware and software arrangements for implementing the processes and functions of the disclosure, the sections below provide details and examples of arrangements for failure handling during L1/L2 Mobility.

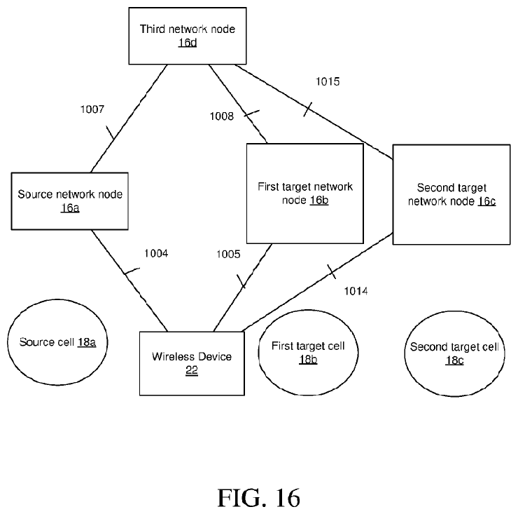

FIG. 16 illustrates an example system architecture corresponding to embodiments of the present disclosure. The wireless device 22, which may be a wireless terminal, such as a cellular smartphone, which may sometimes be connected to the source network node 16a over a wireless interface 1004 and may sometimes be connected to a first target network node 16b, to which the wireless device 22 may be connected over a wireless interface 1005. In some cases, the wireless device 22 may be connected to a second target network node 16c, to which the wireless device 22 may be connected over a wireless interface 1014.

In the context of a mobility procedure, such as a L1/L2 based inter-cell mobility serving cell change procedure, for the wireless device 22, the source network node 16a, sometimes also referred to as the serving network node 16a, controls a source cell 18a and the first target network node 16b controls a first target cell 18b. In the context of a mobility procedure for the wireless device 22, the second target network node 16c controls a second target cell 18c. Each of source network node 16a and the first target network node 16b may be a base station, such as a gNB, or, in case of a distributed CU/DU RAN architecture, a distributed unit, which may be referred to as a gNB-DU or DU. Hence the source network node 16a may correspond to a source DU, which may also be referred to as a serving DU, and the first target network node 16 may correspond to a target DU. Both the source network node 16a and the target network nodes 16b and 16c may be connected to a third network node 16d, which may be referred to as a serving network node 16d.

Further, the third network node 16d may, e.g., in case of a distributed CU/DU RAN architecture, be a central unit, CU, which may be referred to as the serving CU, e.g., a gNB-CU, CU, gNB-CU-CP, gNB-CU-UP, etc., and/or a core network 14 function/node such as a User Plane Function, UPF or an Access and Mobility management Function, AMF.

The second target network node 16c may be a base station, e.g., a gNB, or, in the case of a distributed CU/DU RAN architecture, a distributed unit, sometimes referred to as a gNB-DU or DU.

The third network node 16d may be connected with the source network node 16a over an interface 1007, with the first target network node 16b over an interface 1008 and the second target network node 16c over an interface 1015. Each of the interfaces 1007, 1008 and 1014 may, e.g., in case of a distributed CU/DU RAN architecture, be an F1, F1-U, F1-C, etc. type of interface, and/or an NG type of interface.

In describing some embodiments of the present disclosure, the term “L1/L2 based inter-cell mobility” may be used interchangeably with the terms L1/L2 mobility, L1-mobility, L1 based mobility, L1/L2-centric inter-cell mobility or L1/L2 inter-cell mobility, etc.

L1/L2 based inter-cell mobility may include the wireless device 22 receiving a lower layer signaling from the network node 16 indicating to the wireless device 22 a change of its serving cell 18 (e.g., change of PCell, from a source to a target PCell), possibly along with a change of beam to be monitored for a control channel, e.g., a change of Transmission Configuration Indication (TCI) state, where a lower layer signaling is a message/signaling of a lower layer protocol.

A lower layer protocol may refer to a lower layer protocol in the air interface protocol stack compared to RRC protocol, e.g., Medium Access Control (MAC) may be considered a lower layer protocol as it is “below” RRC in the air interface protocol stack, and in this case a lower layer signaling/message may correspond to a MAC Control Element (MAC CE). Another example of lower layer protocol is the Layer 1 (or Physical Layer, L1), and in this case a lower layer signaling/message may correspond to a Downlink Control Information (DCI). In a multi-beam scenario, a cell 18 may be associated with multiple SSBs, and during a time period/interval (e.g., a half-frame), different SSBs may be transmitted in different spatial directions (i.e., using different beams, spanning the coverage area of a cell 18). Similar features may be applicable to Channel State Information (CSI) Reference Signal (RS) (CSI-RS) resources, which may also be transmitted in different spatial directions.

The phrase “L1/L2 based inter-cell mobility serving cell change procedure” may refer to a process of a wireless device 22 changing its cell 18 from a source cell 18 to a L1/L2 based inter-cell mobility candidate target cell 18, using L1/L2 based inter-cell mobility.

The phrase “Lower layer signaling indicating to the wireless device 22 the L1/L2 based inter-cell mobility serving cell change procedure” may refer to a message/signal/indication/etc. that is sent by the source network node 16 to the wireless device 22 to provide the wireless device 22 with the information required for the L1/L2 based inter-cell mobility serving cell change procedure. The signaling being ‘lower layer’ may refer to the signalling being at a layer of the protocol stack below the RRC layer, for example signaling in L1 and/or L2. For example, the lower layer signaling indicating to the wireless device 22 the L1/L2 based inter-cell mobility serving cell change procedure, may not be RRC signaling, and/or signaling in Layer 3 or above.

In embodiments of the present disclosure, at least one configuration of a L1/L2 based inter-cell mobility candidate target cell 18 may be provided, where the wireless device 22 may be configured with at least one L1/L2 based inter-cell mobility candidate target cell 18. This configuration may be an RRC configuration, such as encapsulated in an RRC Reconfiguration message, that the wireless device 22 receives (e.g., from a network node 16) when being configured with inter-DU L1/L2 inter-cell mobility. The configuration of a L1/L2 based inter-cell mobility candidate target cell 18 may include the configuration which the wireless device 22 needs to start to operate accordingly when it performs L1/L2 based inter-cell mobility serving cell change procedure to that L1/L2 based inter-cell mobility candidate target cell 18, such as upon reception of the Lower layer signaling indicating to the wireless device 22 the L1/L2 based inter-cell mobility serving cell change procedure to that L1/L2 based inter-cell mobility candidate target cell 18, which may become the target cell 18 and/or the current (new) PCell, or an SCell in a serving frequency. The configuration of a L1/L2 based inter-cell mobility candidate target cell 18 may include parameters of a serving cell 18 (or of multiple serving cells 18), and may include one or more of the groups of parameters within the IE SpCellConfig (or the IE SCellConfig, in the case of a Secondary Cell 18).

### SOME EXAMPLE EMBODIMENTS

Embodiment A1. Methods for a wireless device 22 (e.g., a UE), with at least one configuration of a L1/L2 based inter-cell mobility candidate target cell 18, to handle radio related failures.

Embodiment A2. A method according to Embodiment A1 wherein the radio related failure is one of:
A beam failure detection (BFD), e.g., as defined in 3GPP TS 38.321;
A failure to execute a L1/L2 based inter-cell mobility serving cell change procedure;
A handover failure (HOF), e.g., expiry of timer T304;
A radio link failure (RLF), e.g., expiry of timer T310 or T316; and
A failure to (re) transmit a maximum number N of RLC PDU.

Embodiment A3. A method according to Embodiment A1 wherein the wireless device 22 executes a L1/L2 based inter-cell mobility serving cell change procedure from a source cell 18 to a target cell 18.

Embodiment A4. A method according to Embodiment A1 wherein the wireless device 22 transmits, to a source network node 16 or first or second target network node 16, an indication that the wireless device 22 has executed a L1/L2 based inter-cell mobility serving cell change procedure.

Embodiment A4a. A method according to Embodiment A4, wherein the indication that the wireless device 22 has executed a L1/L2 based inter-cell mobility serving cell change procedure is transmitted by using a new or an existing RRC message, or a lower layer indication such as MAC CE or DCI.

Embodiment A5. The method in Embodiment A1 wherein the wireless device 22 transmits, to a source network node 16 or first or second target network node 16, an indication that the wireless device 22 has detected/determined a radio related failure.
The method (of, for example, Emb. A5), wherein the indication includes the type of radio related failure, such as beam failure, failure to execute a L1/L2 based inter-cell mobility serving cell change procedure, handover failure, radio link failure.
The method (of, for example, Emb. A5), wherein the indication further includes the latest available measurements on the configured L1/L2 based inter-cell mobility candidate target cell 18.
The method (of, for example, Emb. A5), wherein the indication further includes a suggestion on what the best L1/L2 based inter-cell mobility candidate target cell 18 is at the time of when the failure event has been detected/determined.

Embodiment A5a. A method according to Embodiment A5, wherein the indication that the wireless device 22 has executed a L1/L2 based inter-cell mobility serving cell change procedure is transmitted by using a new or an existing RRC message, or a lower layer indication such as MAC CE or DCI.

Embodiment A6. A method according to Embodiment A5 wherein the wireless device 22 after having transmitted an indication, receives, from the source network node 16 or the first or second target network node 16, a message, as response to that message, determines whether to execute a L1/L2 based inter-cell mobility serving cell change procedure to a L1/L2 based inter-cell mobility candidate target cell 18

Embodiment A7. A method according to Embodiment A4 wherein the wireless device 22 after having transmitted an indication, receives, from the source network node 16 or the first or second target network node 16, a message, which confirms that the wireless device 22 has executed a L1/L2 based inter-cell mobility serving cell change procedure has been executed to a L1/L2 based inter-cell mobility candidate target cell 18.

Embodiment A8. A method according to Embodiment A1 wherein the wireless device 22 receives, from the source network node 16 or a third network node 16, a configuration for the wireless device 22 to handle radio related failures, including configuration of execution of a L1/L2 based inter-cell mobility serving cell change procedure after a radio related failure detected/determined by the wireless device 22.
The method (of, for example, Emb. A8), where the configuration is an indication that the wireless device 22 is allowed to perform the L1/L2 based inter-cell mobility serving cell change procedure upon detection of a radio related failure. Thus, when the radio related failure is detected/determined, the wireless device 22 only determines to perform a L1/L2 based inter-cell mobility serving cell change procedure if the indication has been configured. The indication may be configured per candidate target cell 18
The method (of, for example, Emb. A8) where the configuration is an information element or a field, associated with a L1/L2 based inter-cell mobility candidate target cell 18.
The method (of, for example, Emb. A8) where the wireless device 22 uses the configuration to determine whether to execute a L1/L2 based inter-cell mobility serving cell change procedure to a L1/L2 based inter-cell mobility candidate target cell 18 after a radio related failure has been detected/determined.

Embodiment A9. In a set of embodiments, the wireless device 22 configured with one or more L1/L2 based inter-cell mobility candidate target cell(s) 18 detects/determines as a radio related failure a Radio Link Failure (e.g. due to the expiry of timer T310 or T316, as defined in TS 38.331). In response, the wireless device 22 performs a L1/L2 based inter-cell mobility serving cell change procedure to one of the L1/L2 based inter-cell mobility candidate target cells 18 the wireless device 22 is configured with.
In one embodiment (according to Emb. A9), in response to the RLF, the wireless device 22 initiates an RRC re-establishment procedure, starts timer T311 and performs cell selection. If the selected cell 18 is one of the L1/L2 based inter-cell mobility candidate target cells 18 the wireless device 22 is configured with, the wireless device 22 performs the L1/L2 based inter-cell mobility serving cell change procedure (i.e. the execution); else, the wireless device 22 continues with the re-establishment procedure by transmitting an RRC Reestablishment Request message to the selected cell 18;
In one embodiment (of, for example, Emb. A9), in response to the RLF, the wireless device 22 initiates an RRC re-establishment procedure, starts timer T311 and performs cell selection. During cell selection, the wireless device 22 prioritizes cells 18 which are L1/L2 based inter-cell mobility candidate target cells 18 the wireless device 22 is configured with.
   For example, while timer T311 is running the wireless device 22 initially search for cells 18 which are among its configured L1/L2 based inter-cell mobility candidate target cells 18 and if finds at least one cell 18 which is suitable, the wireless device 22 performs cell selection to that cell 18 and executes the L1/L2 based inter-cell mobility serving cell change procedure; if none of the candidate cells 18 are suitable, the wireless device 22 selects another suitable cell 18 and continues with the re-establishment procedure by transmitting an RRC Reestablishment Request message to the selected cell 18.
   For example, the wireless device 22 initially search for cells 18 which are among its configured L1/L2 based inter-cell mobility candidate target cells 18 and if multiple candidates are suitable, the wireless device 22 performs the L1/L2 based inter-cell mobility serving cell change procedure to the candidate with strongest RSRP (and/or RSRQ and/or SINR); if none of these cells 18 are suitable, the wireless device 22 continues with the re-establishment procedure by transmitting an RRC Reestablishment Request message to the selected cell 18.
   For example, the wireless device 22 initially search for cells 18 which are among its configured L1/L2 based inter-cell mobility candidate target cells 18 and if multiple candidates are suitable, the wireless device 22 performs the L1/L2 based inter-cell mobility serving cell change procedure to the candidate with the highest priority; if none of these cells 18 are suitable, the wireless device 22 continues with the re-establishment procedure by transmitting an RRC Reestablishment Request message to the selected cell 18.
In one embodiment (of, for example, Emb. A9), the RLF is a Master Cell Group RLF (MCG RLF or M-RLF); thus, the candidates are for PCell;
In one embodiment (of, for example, Emb. A9), the RLF is a Secondary Cell Group RLF (SCG RLF or S-RLF); thus, the candidates are for PSCell;
In one embodiment (of, for example, Emb. A9), the RLF is over a secondary cell 18 (SCell RLF); thus, the candidates are for SCell;
In one embodiment (of, for example, Emb. A9), if the wireless device 22 is configured with a P(S) Cell and one or more SCell(s) 18, in response to the RLF on the PCell or PSCell, the wireless device 22 execute the L1/L2 based inter-cell mobility serving cell change procedure to one of the configured SCells (activated or deactivated) if this SCell is a L1/L2 based inter-cell mobility candidate target cell 18.

Embodiment A10. In a set of embodiments, the wireless device 22 configured with one or more L1/L2 based inter-cell mobility candidate target cell(s) 18 and one or more Conditional Handover (CHO) candidate cell(s) 18 detects/determines as a radio related failure a Radio Link Failure (e.g. due to the expiry of timer T310, as defined in TS 38.331). In response, the wireless device 22 performs a L1/L2 based inter-cell mobility serving cell change procedure to one of the L1/L2 based inter-cell mobility candidate target cells 18 the wireless device 22 is configured with, instead of a Conditional Handover.
In one embodiment (of, for example, Emb. A10), in response to the RLF, the wireless device 22 initiates an RRC re-establishment procedure, starts timer T311 and performs cell selection. If the selected cell 18 is one of the L1/L2 based inter-cell mobility candidate target cells 18 the wireless device 22 is configured with, the wireless device 22 performs the L1/L2 based inter-cell mobility serving cell change procedure (i.e. the execution); else, if the selected cell 18 is a CHO candidate cell 18, the wireless device 22 performs CHO; else, if the candidate cell 18 is not a CHO candidate nor a L1/L2 based inter-cell mobility candidate target cell, the wireless device 22 continues with the re-establishment procedure by transmitting an RRC Reestablishment Request message to the selected cell 18;
In one embodiment (of, for example, Emb. A10), in response to the RLF, the wireless device 22 initiates an RRC re-establishment procedure, starts timer T311 and performs cell selection. During cell selection, the wireless device 22 prioritizes cells 18 which are L1/L2 based inter-cell mobility candidate target cells 18 the wireless device 22 is configured with.
   For example, while timer T311 is running the wireless device 22 initially search for cells 18 which are among its configured L1/L2 based inter-cell mobility candidate target cells 18 and if finds at least one cell 18 which is suitable, the wireless device 22 performs cell selection to that cell 18, and executes the L1/L2 based inter-cell mobility serving cell change procedure; if none of the L1/L2 based inter-cell mobility candidate target cells 18 are suitable, the wireless device 22 search for cells 18 which are among its configured CHO candidate cells 18 and if finds at least one cell 18 which is suitable, the wireless device 22 performs CHO execution; Else, the wireless device 22 selects another suitable cell 18, and continues with the re-establishment procedure by transmitting an RRC Reestablishment Request message to the selected cell 18.
   For example, the wireless device 22 initially search for cells 18 which are among its configured L1/L2 based inter-cell mobility candidate target cells 18 and if multiple candidates are suitable, the wireless device 22 performs the L1/L2 based inter-cell mobility serving cell change procedure to the candidate with strongest RSRP (and/or RSRQ and/or SINR); if none of these cells 18 are suitable, the wireless device 22 continues with the re-establishment procedure by transmitting an RRC Reestablishment Request message to the selected cell 18.
   For example, the wireless device 22 initially search for cells 18 which are among its configured L1/L2 based inter-cell mobility candidate target cell s and if multiple candidates are suitable, the wireless device 22 performs the L1/L2 based inter-cell mobility serving cell change procedure to the candidate with the highest priority; if none of these cells 18 are suitable, the wireless device 22 continues with the re-establishment procedure by transmitting an RRC Reestablishment Request message to the selected cell 18.
In one embodiment (of, for example, Emb. A10), the RLF is a Master Cell Group RLF (MCG RLF or M-RLF); thus, the candidates are for PCell;
In one embodiment (of, for example, Emb. A10), the RLF is a Secondary Cell Group RLF (SCG RLF or S-RLF); thus, the candidates are for PSCell;
In one embodiment (of, for example, Emb. A10), the RLF is over a secondary cell (SCell RLF); thus, the candidates are for SCell;
In one embodiment (of, for example, Emb. A10), if the wireless device 22 is configured with a P(S) Cell, and one or more SCell(s), in response to the RLF on the PCell or PSCell, the wireless device 22 execute the L1/L2 based inter-cell mobility serving cell change procedure to one of the configured SCells (activated or deactivated) if this SCell is a L1/L2 based inter-cell mobility candidate target cell

Embodiment A11. In one set of embodiments, in addition to selecting a L1/L2 based inter-cell mobility candidate target cell to perform the L1/L2 based inter-cell mobility serving cell change procedure upon RLF, the wireless device 22 also selects a beam or a Reference Signal (RS) or Synchronization Signal (SS) associated (e.g. SSB index and/or CSI-RS resource identifier). That step is needed since the wireless device 22 may not have received from the network a beam indication (e.g. TCI state indication or SSB indication) for the execution of L1/L2 based inter-cell mobility serving cell change procedure.
In one option the selected beam corresponds to a beam whose measurements are above a configured threshold, e.g., beam corresponding to an SSB whose SS-RSRP is above an RSRP threshold.
In one option the selected beam corresponds to a beam whose measurement is the strongest compared to the measurements of other beams, e.g., beam corresponding to the SSB whose SS-RSRP is the strongest.
In one option the selected SSB index (of the selected L1/L2 based inter-cell mobility candidate target cell) corresponds to an SSB whose measurements are above a configured threshold, e.g., SSB index whose SS-RSRP is above an RSRP threshold.
In one option the selected SSB index corresponds to a the SSB whose measurement is the strongest compared to the measurements of other SSBs of the selected L1/L2 based inter-cell mobility candidate target cell, e.g., SSB whose SS-RSRP is the strongest.
In one option the wireless device 22 indicates the selected beam to the network during the execution of a L1/L2 based inter-cell mobility serving cell change procedure, e.g., by transmitting a MAC CE to the selected cell 18 including the selected beam.
In one option the wireless device 22 indicates the selected SSB index to the network during the execution of a L1/L2 based inter-cell mobility serving cell change procedure, e.g., by transmitting a MAC CE to the selected cell 18 including the index of the selected SSB.
In one option the wireless device 22 indicates the selected CSI-RS resource identifier to the network during the execution of a L1/L2 based inter-cell mobility serving cell change procedure, e.g., by transmitting a MAC CE to the selected cell 18 including the resource identifier of the selected CSI-RS.
In one option the selected beam corresponds to a beam of the L1/L2 based inter-cell mobility candidate target cell which is a candidate beam i.e. which is configured as a QCL source (e.g. type D) of a TCI state of the L1/L2 based inter-cell mobility candidate target cell.
In one option the selected SSB corresponds to an SSB of the L1/L2 based inter-cell mobility candidate target cell 18 which is configured as a QCL source (e.g. type D) of a TCI state of the selected L1/L2 based inter-cell mobility candidate target cell 18.

Embodiment A12. In a set of embodiments, upon the radio related failure, the wireless device 22 searches for a beam or RS or SS associated (e.g. SSB index and/or CSI-RS resource identifier) associated to a L1/L2 based inter-cell mobility candidate target cell 18. The wireless device 22 selects a beam of the L1/L2 based inter-cell mobility candidate target cell 18 and performs a L1/L2 based inter-cell mobility serving cell change procedure to the selected beam and its associated cell 18.
In one embodiment (of, for example, Emb. A12), the wireless device 22 searches for selection a beam of the L1/L2 based inter-cell mobility candidate target cell 18 which is a candidate beam i.e. which is configured as a QCL source (e.g. type D) of a TCI state of the L1/L2 based inter-cell mobility candidate target cell 18.
In one embodiment (of, for example, Emb. A12), the wireless device 22 searches for selection an SSB corresponding to an SSB of the L1/L2 based inter-cell mobility candidate target cell(s) 18 which are configured as a QCL source (e.g. type D) of a TCI state of the selected L1/L2 based inter-cell mobility candidate target cell 18.
In one embodiment (of, for example, Emb. A12), the wireless device 22 searches for selection a CSI-RS resource corresponding to a CSI-RS resource of the L1/L2 based inter-cell mobility candidate target cell(s) 18 which are configured as a QCL source (e.g. type D) of a TCI state of the selected L1/L2 L1/L2 based inter-cell mobility candidate target cell 18.

Embodiment A13. In a set of embodiments, the wireless device 22 configured with one or more L1/L2 based inter-cell mobility candidate target cell(s) 18 detects/determines as a radio related failure a Beam Failure Detection (BFD), e.g., due to maximum count of Beam Failure Indications (BFIs) from lower layer at the wireless device 22 received at the MAC entity being reached, as defined in TS 38.321. In response, the wireless device 22 performs a L1/L2 based inter-cell mobility serving cell change procedure to one of the L1/L2 based inter-cell mobility candidate target cell 18 the wireless device 22 is configured with, instead of BFD.
In one embodiment (of, for example, Emb. A13), upon BFD the wireless device 22 selects a candidate beam among the candidate beams configured for Beam Failure Recovery (BFR), e.g., a beam of the serving cell 18 (where BFD was declared) and/or of a beam of one of the L1/L2 based inter-cell mobility candidate target cell(s) 18. If the selected beam (e.g. beam whose measurement is above a threshold, like SS-RSR above threshold) is a beam which is configured as QCL source of a L1/L2 based inter-cell mobility candidate target cell 18, the wireless device 22 executes a L1/L2 based inter-cell mobility serving cell change procedure to the L1/L2 based inter-cell mobility candidate target cell 18 of that selected beam. Else, If the selected beam (e.g. beam whose measurement is above a threshold, like SS-RSR above threshold) is NOT a beam which is configured as QCL source of a L1/L2 based inter-cell mobility candidate target cell 18, the wireless device 22 performs BFR towards the selected beam and/or cell.
In one embodiment (of, for example, Emb. A13), upon BFD the wireless device 22 selects a an SSB among the candidate SSBs configured for BFR, e.g., an SSB of the serving cell 18 (where BFD was declared) and/or of an SSB of one of the L1/L2 based inter-cell mobility candidate target cell(s) 18. If the selected SSB, e.g., SSB whose measurement is above a threshold, like SS-RSR above threshold, is an SSB which is configured as QCL source of a L1/L2 based inter-cell mobility candidate target cell 18 (e.g. type D), the wireless device 22 executes a L1/L2 based inter-cell mobility serving cell change procedure to the L1/L2 based inter-cell mobility candidate target cell 18 of that selected SSB. Else, If the selected SSB (e.g. SSB whose measurement is above a threshold, like SS-RSR above threshold) is NOT an SSB which is configured as QCL source of a L1/L2 based inter-cell mobility candidate target cell 18, the wireless device 22 performs BFR towards the selected SSB and/or cell.
In one embodiment (of, for example, Emb. A13), upon BFD the wireless device 22 selects a CSI-RS resource among the candidate CSI-RS resources configured for BFR, e.g., a CSI-RS resource of the serving cell 18 (where BFD was declared) and/or of a CSI-RS resource of one of the L1/L2 based inter-cell mobility candidate target cell(s) 18. If the selected CSI-RS resource, e.g., CSI-RS resource whose measurement is above a threshold, like CSI-RSRP above threshold, is a CSI-RS resource which is configured as QCL source of a L1/L2 inter-cell mobility candidate cell 18 (e.g. type D), the wireless device 22 executes a L1/L2 based inter-cell mobility serving cell change procedure to the L1/L2 based inter-cell mobility candidate target cell 18 of that selected CSI-RS resource. Else, If the selected CSI-RS resource (e.g. CSI-RS resource whose measurement is above a threshold, like CSI-RSRP above threshold) is NOT a CSI-RS resource which is configured as QCL source of a L1/L2 based inter-cell mobility candidate target cell 18, the wireless device 22 performs BFR towards the selected CSI-RS resource and/or cell.
Prioritization of candidate beams configured for L1/L2 inter-cell mobility: In one embodiment (of, for example, Emb. A13), upon BFD, the wireless device 22 prioritizes the search and/or selection of a beam or RS or SS associated (e.g. SSB index and/or CSI-RS resource identifier) of a L1/L2 based inter-cell mobility candidate target cell 18. In other words, prioritizes a beam configured as QCL source (e.g. type D) of a L1/L2 based inter-cell mobility candidate target cell 18.
   For example, the wireless device 22 initially search for beams configured as QCL source (e.g. Type D) within L1/L2 based inter-cell mobility candidate target cells 18 and if the wireless device 22 finds at least one beam which is suitable (beam measurement above a threshold, e.g., SS-RSRP), the wireless device 22 selects that beam to execute the L1/L2 based inter-cell mobility serving cell change procedure in the selected beam (and associated L1/L2 based inter-cell mobility candidate target cell 18).
      Else, if none of the beams configured as QCL source (e.g. Type D) within L1/L2 based inter-cell mobility candidate target cells 18 are suitable, the wireless device 22 selects another beam of a L1/L2 based inter-cell mobility candidate target cell 18 which is a BFR candidate beam and continues to perform a BFR in the selected beam of the selected L1/L2 based inter-cell mobility candidate target cell 18.
   For example, the wireless device 22 initially search for SSBs configured as QCL source (e.g. Type D) within L1/L2 based inter-cell mobility candidate target cell 18 and if the wireless device 22 finds at least one SSB which is suitable (SS-RSRP above a threshold), the wireless device 22 selects that SSB to execute the L1/L2 based inter-cell mobility serving cell change procedure in the selected SSB (and associated L1/L2 based inter-cell mobility candidate target cell 18).
      Else, if none of the SSBs configured as QCL source (e.g. Type D) within L1/L2 inter-cell mobility candidate cells 18 are suitable, the wireless device 22 selects another SSB of a L1/L2 based inter-cell mobility candidate target cell 18 which is a BFR candidate SSB and continues to perform a BFR in the selected SSB of the selected L1/L2 based inter-cell mobility candidate target cell 18.
   For example, the wireless device 22 initially search for beams configured as QCL source (e.g. Type D) within L1/L2 based inter-cell mobility candidate target cells 18 and if multiple beams are suitable (i.e. multiple beams have measurements above a threshold, e.g., SS-RSRP), the wireless device 22 performs the L1/L2 based inter-cell mobility serving cell change procedure to the beam with strongest RSRP (and/or RSRQ and/or SINR);
      Else, if none of the beams configured as QCL source (e.g. Type D) within L1/L2 based inter-cell mobility candidate target cells 18 are suitable, the wireless device 22 selects another beam of a L1/L2 based inter-cell mobility candidate target cell 18 which is a BFR candidate beam and continues to perform a BFR in the selected beam of the selected candidate cell 18.
   For example, the wireless device 22 initially search for SSBs configured as QCL source (e.g. Type D) within L1/L2 based inter-cell mobility candidate target cells 18 and if multiple SSBs are suitable (i.e. multiple SSBs have measurements above a threshold, e.g., SS-RSRP), the wireless device 22 performs the L1/L2 based inter-cell mobility serving cell change procedure to the SSB with strongest RSRP (and/or RSRQ and/or SINR);
      Else, if none of the SSBs configured as QCL source (e.g. Type D) within L1/L2 based inter-cell mobility candidate target cells 18 are suitable, the wireless device 22 selects another SSB of a L1/L2 based inter-cell mobility candidate target cell 18 which is a BFR candidate SSB and continues to perform a BFR in the selected SSB of the selected L1/L2 based inter-cell mobility candidate target cell 18.

Embodiment B1. Methods for a source network node 16 (e.g., source DU), such as a source gNB, a source DU or a source CU, to handle radio related failures for a wireless device 22 with at least one configuration of a L1/L2 based inter-cell mobility candidate target cell 18.

Embodiment B2. A method according to Embodiment B1 wherein the source network node 16 transmits, to the wireless device 22, a configuration for the wireless device 22 to handle radio related failures, including configuration of execution of a L1/L2 based inter-cell mobility serving cell change procedure after a radio related failure detected/determined by the wireless device 22.

Embodiment B3. A method according to Embodiment B1 wherein the source network node 16 configures the wireless device 22 with an indication that the wireless device 22 is allowed to perform the L1/L2 based inter-cell mobility serving cell change procedure upon detection of a radio related failure.

Embodiment B4. A method according to Embodiment B1 wherein the source network node 16 receives an indication, from a target network node 16 or a third network node 16, that the wireless device 22 has executed a L1/L2 based inter-cell mobility serving cell change procedure

Embodiment B5. A method according to Embodiment B4 wherein the indication indicates that a radio related failure was detected/determined by the wireless device 22.

Embodiment B6. A method according to Embodiment B1, wherein the source network node 16 transmits, to the (source) CU, an indication that the wireless device 22 has executed a L1/L2 based inter-cell mobility serving cell change procedure.

Embodiment B7. A method according to Embodiment B1, wherein the source network node 16 transmits, to the (source) CU, an indication that the wireless device 22 has detected/determined a radio related failure.

Embodiment B8. A method according to Embodiment B1, wherein the source network node 16 receives, from the wireless device 22, an indication that a radio related failure was detected/determined by the wireless device 22.

Embodiment B9. A method according to Embodiment B8, wherein the indication is that the wireless device 22 failed to execute a L1/L2 based inter-cell mobility serving cell change procedure

Embodiment B10. A method according to Embodiments B8 or B9, wherein as response the source network node 16 transmits, to the wireless device 22, a request a L1/L2 based inter-cell mobility serving cell change procedure for a new target cell

Embodiment C1. Methods for a third network node 16 (CU) (or serving network node 16), such as a (serving) Central Unit (CU), (serving) gNB-CU, to handle radio related failures for a wireless device 22 with at least one configuration of a L1/L2 based inter-cell mobility candidate target cell 18.

Embodiment C2. A method according to Embodiment C1 wherein the third network node 16 transmits, to the wireless device 22 or a source network node 16, a configuration for the wireless device 22 to handle radio related failures, including configuration of execution of a L1/L2 based inter-cell mobility serving cell change procedure after a radio related failure detected/determined by the wireless device 22.

Embodiment C3. A method according to Embodiment C1 wherein the third network node 16 configures the wireless device 22 with an indication that the wireless device 22 is allowed to perform the L1/L2 based inter-cell mobility serving cell change procedure upon detection of a radio related failure.
In one example, the indication is common for all the L1/L2 based inter-cell mobility candidate cells 18 (e.g., a 1-bit indication).
In one example, the indication is specific for a L1/L2 based inter-cell mobility candidate cell 18. In this case, the indication may be e.g., a 1-bit indication within the configuration for a L1/L2 based inter-cell mobility candidate cell 18.
In one example, the indication is specific for a L1/L2 based inter-cell mobility candidate cell 18. In this case, the indication may be e.g., a bit string with size equal to the configured L1/L2 based inter-cell mobility candidate cells 18.

Embodiment C4. A method according to Embodiment C1 wherein the third network node 16 receives, from a first or second target network node 16, an indication that the wireless device 22 has executed a L1/L2 based inter-cell mobility serving cell change procedure.

Embodiment C5. A method according to Embodiment C1, wherein the third network node 16 transmits, to a source network node 16, an indication that the wireless device 22 has executed a L1/L2 based inter-cell mobility serving cell change procedure.

Embodiment C6. A method according to Embodiment C1 wherein, the third network node 16 receives, from a serving network node 16, an indication that the wireless device 22 has executed a L1/L2 based inter-cell mobility serving cell change procedure.

Embodiment C7. A method according to Embodiment C4, C5, or C6 wherein the indication indicates that a radio related failure was detected/determined by the wireless device 22.

Embodiment D1. Methods for a first target network node 16 (first target DU), such as a target gNB, a target DU, or a target CU, to handle radio related failures for a wireless device 22 with at least one configuration of a L1/L2 based inter-cell mobility candidate target cell 18.

Embodiment D2. A method according to Embodiment D1 wherein the first target network node 16 receives, from the wireless device 22, an indication that the wireless device 22 has executed a L1/L2 based inter-cell mobility serving cell change procedure.

Embodiment D3. A method according to Embodiment D1 wherein the first target network node 16 transmits, to a source network node 16 or a third network node 16, an indication that the wireless device 22 has executed a L1/L2 based inter-cell mobility serving cell change procedure.

Embodiment D4. A method according to Embodiment D1, wherein the first target network node 16 receives, from a third network node 16, an indication that the wireless device 22 has executed a L1/L2 based inter-cell mobility serving cell change procedure.

Embodiment D5. A method according to Embodiments D2, D3, and/or D4, wherein the indication indicates that a radio related failure was detected/determined by the wireless device 22.

Embodiment D6. A method according to Embodiment D1, wherein the first target network node 16 includes in the configuration of a L1/L2 based inter-cell mobility candidate target cell 18 an indication that the wireless device 22 is allowed to perform the L1/L2 based inter-cell mobility serving cell change procedure on this of a L1/L2 based inter-cell mobility candidate target cell 18 upon detection of a radio related failure.
In one example, the indication is specific for a L1/L2 based inter-cell mobility candidate target cell 18. In this case, the indication may be e.g., a 1-bit indication within the configuration for a L1/L2 based inter-cell mobility candidate target cell 18.

Embodiment E1. Methods for a second target network node 16 (second target DU), such as a target gNB, a target DU, or a target CU, to handle radio related failures for a wireless device 22 with at least one configuration of a L1/L2 based inter-cell mobility candidate target cell 18.

Embodiment E2. A method according to Embodiment E1 wherein the second target network node 16 receives, from the wireless device 22, an indication that the wireless device 22 has executed a L1/L2 based inter-cell mobility serving cell change procedure

Embodiment E3. A method according to Embodiment E1 wherein the second target network node 16 transmits, to a source network node 16 or a third network node 16, an indication that the wireless device 22 has executed a L1/L2 based inter-cell mobility serving cell change procedure.

Embodiment E4. A method according to Embodiment E1, wherein the second target network node 16 receives, from a third network node 16, an indication that the wireless device 22 has executed a L1/L2 based inter-cell mobility serving cell change procedure.

Embodiment E4. A method according to Embodiments E2, E3, or E4 wherein the indication indicates that a radio related failure was detected/determined by the wireless device 22.

Embodiment E5. A method according to Embodiment E1, wherein the second target network node 16 includes in the configuration of a L1/L2 based inter-cell mobility candidate target cell 18 an indication that the wireless device 22 is allowed to perform the L1/L2 based inter-cell mobility serving cell change procedure on this of a L1/L2 based inter-cell mobility candidate target cell 18 upon detection of a radio related failure.
In one example, the indication is specific for a L1/L2 based inter-cell mobility candidate target cell 18. In this case, the indication may be e.g., a 1-bit indication within the configuration for a L1/L2 based inter-cell mobility candidate target cell 18.

### Sequence Diagrams

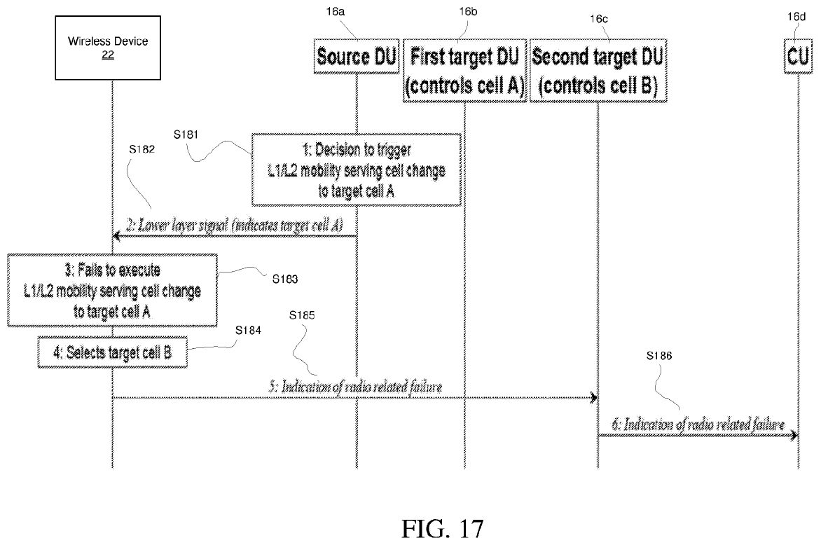

Referring to FIG. 17, an example message sequence chart in one example approach according to some embodiments of the present disclosure (e.g., alternative 1) is provided. In this example, the wireless device 22 is configured with at least one L1/L2 based inter-cell mobility candidate target cell 18, fails to execute a L1/L2 based inter-cell mobility serving cell change procedure to target cell 18b, then selects cell 18c and indicates radio related failure in this cell 18c. Steps in this example include:
Step S181. The source DU 16a decides to trigger a L1/L2 based inter-cell mobility serving cell change procedure to target cell 18b for the wireless device 22.
Step 182. The source DU 16a transmits a lower layer signal to the wireless device 22 to request the execution of L1/L2 based inter-cell mobility serving cell change procedure to target cell 18b.
Step S183. The wireless device 22 fails to execute L1/L2 based inter-cell mobility serving cell change procedure to target cell 18b.
Step S184. The wireless device 22 selects cell 18c.
Step S185. The wireless device 22 transmits an indication of a radio related failure to the second target DU 16c.
Step S186. The second target DU 16c transmits an indication of a radio related failure to the CU 16d.

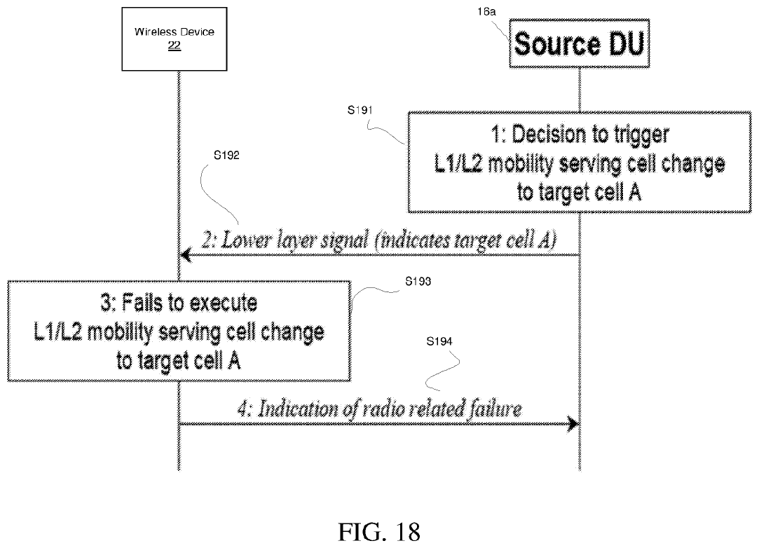

Referring to FIG. 18, an example of a message sequence chart in another example embodiment of the present disclosure (e.g., alternative 1a) is provided. In this example, the wireless device 22 is configured with at least one L1/L2 based inter-cell mobility candidate target cell 18b, fails to execute a L1/L2 based inter-cell mobility serving cell change procedure to target cell 18b and then indicates radio related failure in the source cell 18a. The steps of this example include:
Step S191. The source DU 16a decides to trigger a L1/L2 based inter-cell mobility serving cell change procedure to target cell 18b for the wireless device 22.
Step S192. The source DU 16a transmits a lower layer signal to the wireless device 22 to request the execution of L1/L2 based inter-cell mobility serving cell change procedure to target cell 18b.
Step S193. The wireless device 22 fails to execute L1/L2 based inter-cell mobility serving cell change procedure to target cell 18b.
Step S194. The wireless device 22 transmits an indication of a radio related failure to the source DU 16a.

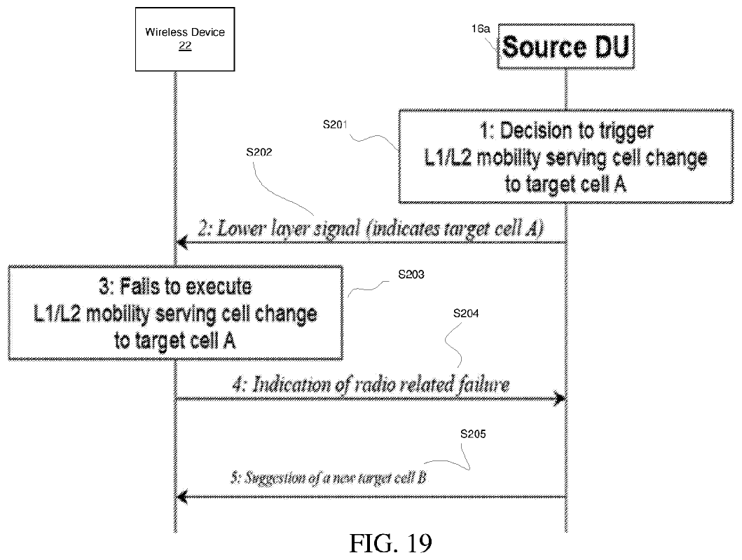

Referring to FIG. 19, a message sequence chart of yet another example embodiment of the present disclosure is provided. In this example, the wireless device 22 is configured with at least one L1/L2 based inter-cell mobility candidate target cell, fails to execute a L1/L2 based inter-cell mobility serving cell change procedure to target cell 18b and then indicates radio related failure in the source cell 18a. The steps of this example include:
Step S201. The source DU 16a decides to trigger a L1/L2 based inter-cell mobility serving cell change procedure to target cell 18b for the wireless device 22.
Step S202. The source DU 16 transmits a lower layer signal to the wireless device 22 to request the execution of L1/L2 based inter-cell mobility serving cell change procedure to target cell 18b.
Step S203. The wireless device 22 fails to execute L1/L2 based inter-cell mobility serving cell change procedure to target cell 18b.
Step S204. The wireless device 22 transmits an indication of a radio related failure to the source DU 16a, which is considered a new request for target cell suggestion.
Step S205. The source DU 16 sends a new indication of suggested cell 18, e.g., cell 18c, to the wireless device 22.

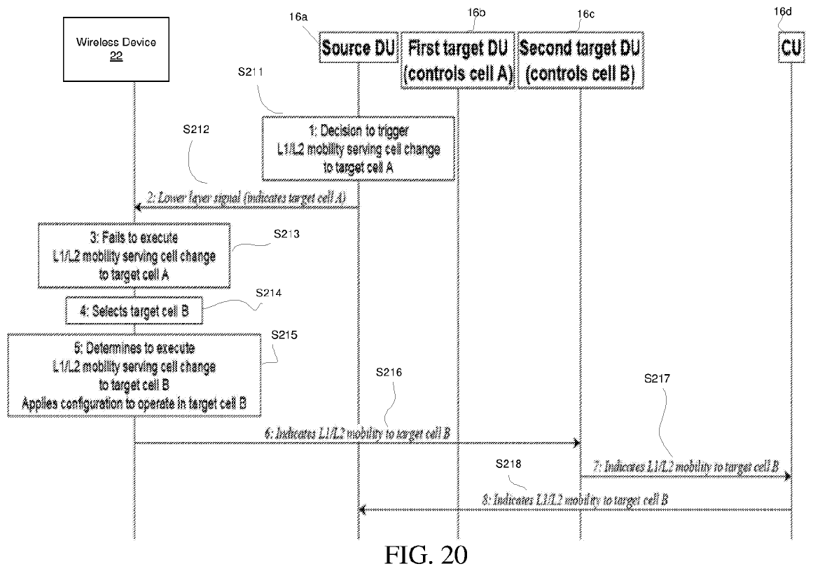

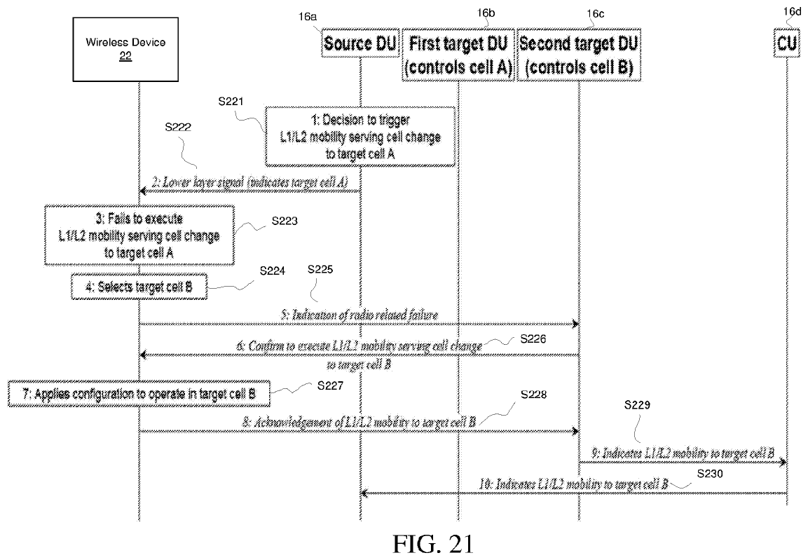

Referring to FIG. 20, a message sequence chart of yet another example embodiment of the present disclosure is provided. In this example, the wireless device 22 is configured with at least one L1/L2 based inter-cell mobility candidate target cell, fails to execute a L1/L2 based inter-cell mobility serving cell change procedure to target cell 18b, then selects cell 18c and determines to execute a L1/L2 based inter-cell mobility serving cell change procedure to target cell 18c. The steps of this example include:
Step S211. The source DU 16a decides to trigger a L1/L2 based inter-cell mobility serving cell change procedure to target cell 18b for the wireless device 22.
Step S212. The source DU 16a transmits a lower layer signal to the wireless device 22 to request the execution of L1/L2 based inter-cell mobility serving cell change procedure to target cell 18b.
Step S213. The wireless device 22 fails to execute L1/L2 based inter-cell mobility serving cell change procedure to target cell 18b.
Step S214. The wireless device 22 selects cell 18c.
Step S215. The wireless device 22 determines to execute a L1/L2 based inter-cell mobility serving cell change procedure to target cell 18c and applies the configuration to operate in target cell 18c.
Step S216. The wireless device 22 transmits an indication in cell 18c to the second target DU 16c that it has executed a L1/L2 based inter-cell mobility serving cell change procedure to target cell 18B.
Step S217. The second target DU 16c sends, to the CU 16d, an indication that the wireless device 22 has executed a L1/L2 based inter-cell mobility serving cell change procedure to target cell 18c.
Step S218. The CU 16d sends, to the source DU 16a, an indication that the wireless device 22 has executed a L1/L2 based inter-cell mobility serving cell change procedure to target cell 18c.

Referring to FIG. 21, a message sequence chart of yet another example embodiment of the present disclosure (e.g., alternative 3) is provided. In this example, the wireless device 22 is configured with at least one L1/L2 based inter-cell mobility candidate target cell 18, fails to execute a L1/L2 based inter-cell mobility serving cell change procedure to target cell 18b, then selects cell 18c, indicates radio related failure in this cell 18c, and then executes a L1/L2 based inter-cell mobility serving cell change procedure to target cell 18c. The steps of this example include:
Step S221. The source DU 16a decides to trigger a L1/L2 based inter-cell mobility serving cell change procedure to target cell 18b for the wireless device 22.
Step S222. The source DU transmits a lower layer signal to the wireless device 22 to request the execution of L1/L2 based inter-cell mobility serving cell change procedure to target cell 18b.
Step S223. The wireless device 22 fails to execute L1/L2 based inter-cell mobility serving cell change procedure to target cell 18b.
Step S224. The wireless device 22 selects cell 18c.
Step S225. The wireless device 22 transmits an indication of a radio related failure to the second target DU 16c.
Step S226. The second target DU 16c transmits an indication to the wireless device 22 to confirm the wireless device 22 to execute L1/L2 based inter-cell mobility serving cell change procedure to target cell 18c.
Step S227. The wireless device 22 executes a L1/L2 based inter-cell mobility serving cell change procedure to target cell 18c and applies the configuration to operate in target cell 18c.
Step S228. The wireless device 22 transmits an indication in cell 18c to the second target DU 16c that it has executed a L1/L2 based inter-cell mobility serving cell change procedure to target cell 18c.
Step S229. The second target DU 16c sends, to the CU 16d an indication that the wireless device 22 has executed a L1/L2 based inter-cell mobility serving cell change procedure to target cell 18c.
Step S230. The CU 16d sends, to the source DU 16a, an indication that the wireless device 22 has executed a L1/L2 based inter-cell mobility serving cell change procedure to target cell 18c.

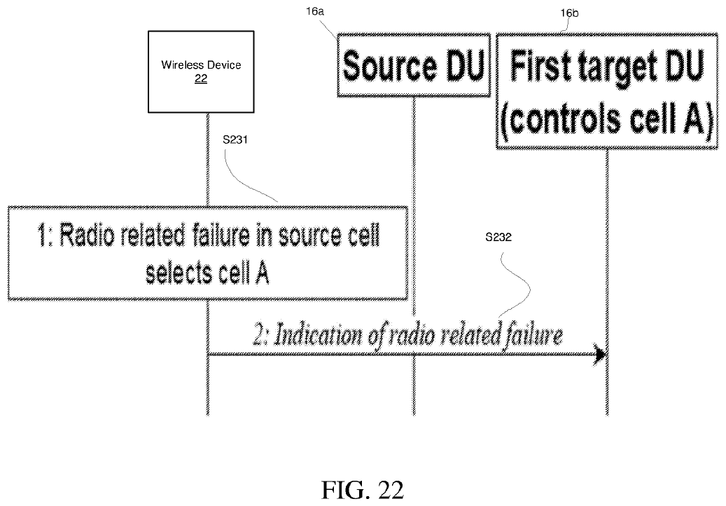

Referring to FIG. 22, a message sequence chart of yet another example embodiment of the present disclosure (e.g., alternative 4) is provided. In this example, the wireless device 22 is configured with at least one L1/L2 based inter-cell mobility candidate target cell 18, detects/determines a radio related failure in the source cell, then selects cell 18b and indicates radio related failure in this cell 18b. The steps of this example include:
Step S231. The wireless device 22 detects/determines a radio related failure in the source cell 18a selects cell 18b.
Step S232. The wireless device 22 transmits an indication of a radio related failure to the first target DU 16b.

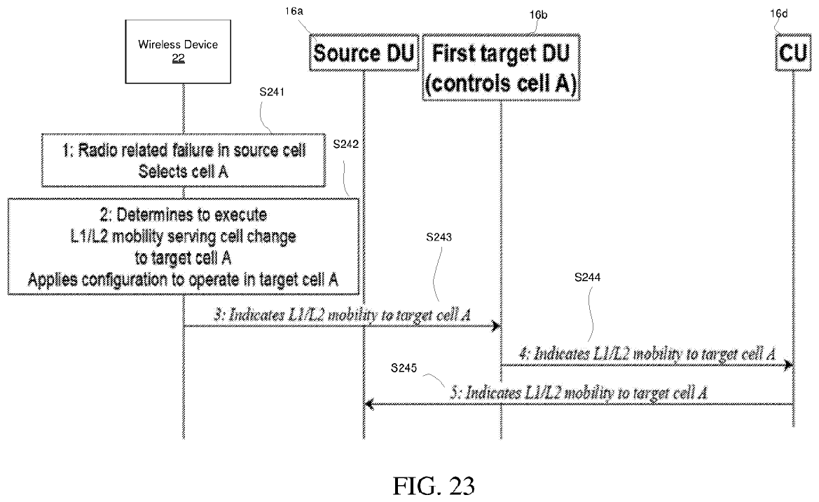

Referring to FIG. 23, a message sequence chart of yet another example embodiment of the present disclosure (e.g., alternative 4a) is provided. In this example, wireless device 22 is configured with at least one L1/L2 based inter-cell mobility candidate target cell 18, detects/determines a radio related failure in the source cell, then selects cell 18b and executes a L1/L2 based inter-cell mobility serving cell change procedure to target cell 18b. The steps of this example include.
Step S241. The wireless device 22 detects/determines a radio related failure in the source cell 18a and selects cell 18b.
Step S242. The wireless device 22 determines to execute a L1/L2 based inter-cell mobility serving cell change procedure to target cell 18b and applies the configuration to operate in target cell 18b.
Step S243. The wireless device 22 transmits an indication in cell 18b to the first target DU 16a that it has executed a L1/L2 based inter-cell mobility serving cell change procedure to target cell 18b.
Step S244. The first target DU 16b sends, to the CU 16d (e.g., another network node 16), an indication that the wireless device 22 has executed a L1/L2 based inter-cell mobility serving cell change procedure to target cell 18b.
Step S245. The CU 16d sends, to the source DU 16a, an indication that the wireless device 22 has executed a L1/L2 based inter-cell mobility serving cell change procedure to target cell 18b.

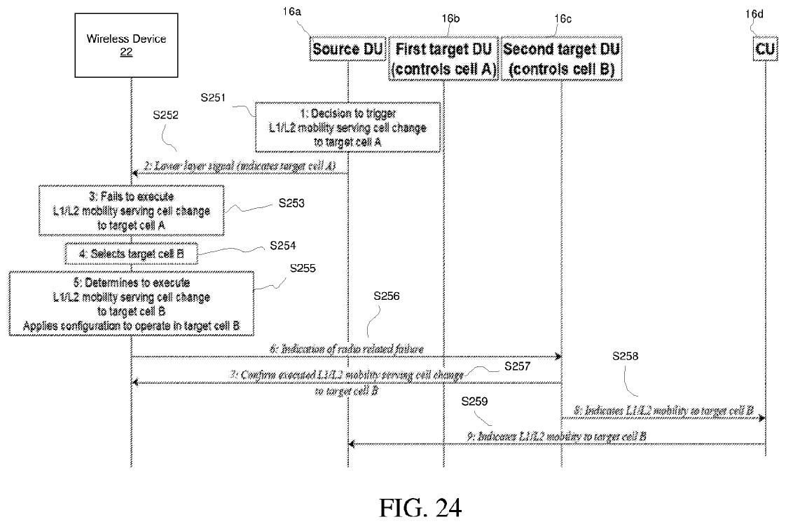

Referring to FIG. 24, a message sequence chart of yet another example embodiment of the present disclosure (alternative 5) is provided. In this example, the wireless device 22 is configured with at least one L1/L2 based inter-cell mobility candidate target cell, fails to execute a L1/L2 based inter-cell mobility serving cell change procedure to target cell 18b, then selects cell 18c, determines to execute a L1/L2 based inter-cell mobility serving cell change procedure to target cell 18c and indicates radio related failure in this cell. The steps of this example include:
Step S251. The source DU 16a decides to trigger a L1/L2 based inter-cell mobility serving cell change procedure to target cell 18b for the wireless device 22.
Step S252. The source DU 16a transmits a lower layer signal to the wireless device 22 to request the execution of L1/L2 based inter-cell mobility serving cell change procedure to target cell 18b.
Step S253. The wireless device 22 fails to execute L1/L2 based inter-cell mobility serving cell change procedure to target cell 18b.
Step S254. The wireless device 22 selects target cell 18c.
Step S255. The wireless device 22 determines to execute a L1/L2 based inter-cell mobility serving cell change procedure to target cell 18c and applies the configuration to operate in target cell 18c.
Step S256. The wireless device 22 transmits an indication of a radio related failure or execution of L1/L2 based inter-cell mobility serving cell change in cell 18c to the second target DU 16c.
Step S257. The second target DU 16c transmits an indication to the wireless device 22 to confirm the wireless device 22 to execute L1/L2 based inter-cell mobility serving cell change procedure to target cell 18c.
Step S258. The second target DU 16c sends, to the CU 16d, an indication that the wireless device 22 has executed a L1/L2 based inter-cell mobility serving cell change procedure to target cell 18c.
Step S259. The CU 16d sends, to the source DU 16a, an indication that the wireless device 22 has executed a L1/L2 based inter-cell mobility serving cell change procedure to target cell 18c.

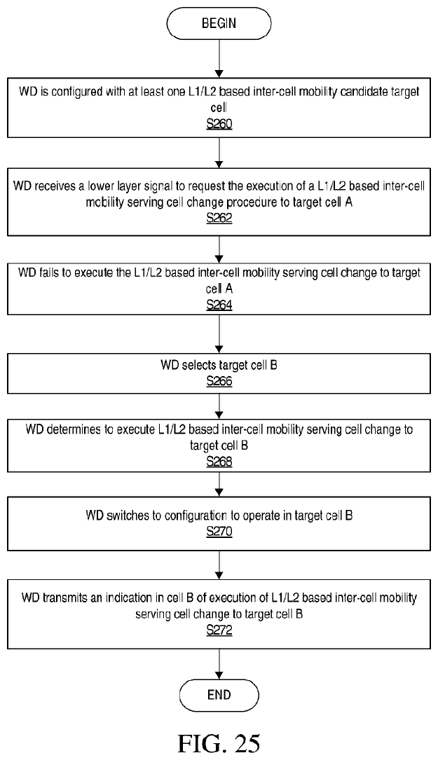

Referring to FIG. 25, a flow chart of steps performed by the wireless device 22 in one example embodiment of the present disclosure is provided. The steps performed, e.g., by the wireless device 22, in this example include:
Step S260. The wireless device 22 is configured with at least one L1/L2 based inter-cell mobility candidate target cell 18.
Step S262. The wireless device 22 receives a lower layer signal to request the execution of a L1/L2 based inter-cell mobility serving cell change procedure to target cell 18b (“Cell A”).
Step S264. The wireless device 22 fails to execute the L1/L2 based inter-cell mobility serving cell change to target cell 18b.
Step S266. The wireless device 22 selects target cell 18c (“Cell B”).
Step S268. The wireless device 22 determines to execute a L1/L2 based inter-cell mobility serving cell change to target cell 18c.
Step S270. The wireless device 22 switches to configuration to operate in target cell 18c.
Step S272. The wireless device 22 transmits an indication in cell 18c of execution of L1/L2 based inter-cell mobility serving cell change to target cell 18c.

### SOME ADDITIONAL EXAMPLES

Example F1. A wireless device 22 configured to communicate with a source network node 16, the wireless device 22 being configured with an inter-cell mobility configuration for handling radio related failures, the wireless device 22 configured to, and/or comprising a radio interface and/or processing circuitry configured to:
attempt to execute the first inter-cell mobility change procedure with a first target network node 16 of a first inter-cell mobility candidate target cell 18 associated with the inter-cell mobility configuration;
determine a first radio related failure associated with the first target network node 16, the first inter-cell mobility candidate target cell 18, and/or the inter-cell mobility change procedure; and
perform at least one wireless device 22 action based on the inter-cell mobility configuration and the determined first radio related failure.

Example F2. The wireless device 22 of Example F1, wherein the wireless device 22 is configured to:
receive a first lower layer signal from a source network node 16 requesting execution of a first inter-cell mobility change procedure; and
the attempting to execute the first inter-cell mobility change procedure being based on the receiving of the first lower layer signal.

Example F3. The wireless device 22 of Example F2, wherein the first lower layer signal from the source network node 16 indicates at least one of the first target network node 16 and the first inter-cell mobility candidate target cell 18.

Example F4. The wireless device 22 of any one of Examples F1-F3, wherein the wireless device 22 is configured to:
detect a source cell 18 radio related failure of a source cell 18 associated with the source network node 16; and
the attempting to execute the first inter-cell mobility change procedure being based on the detecting of the source cell 18 radio related failure.

Example F5. The wireless device 22 of any one of Examples F1-F4, wherein the first radio related failure is at least one of:
a beam failure detection (BFD)
a failure to execute the first inter-cell mobility serving cell 18 change procedure;
a handover failure (HOF) and/or an expiration of a timer associated with the HOF;
a radio link failure (RLF) and/or an expiration of a timer associated with the RLF; and
a failure to transmit a maximum number N of Radio Link Control (RLC) Protocol Data Units (PDU).

Example F6. The wireless device 22 of any one of Examples F1-F5, wherein the performing of the at least one wireless device 22 action includes:
determining a second inter-cell mobility target cell 18 associated with the inter-cell mobility configuration;
cause transmission of a second indication of the first radio related failure to a second target network node 16 associated with the second inter-cell mobility target cell 18.

Example F7. The wireless device 22 of Example F6, wherein the second indication includes at least one of:
a type of the first radio related failure;
a most recent available measurement on the first inter-cell mobility candidate target cell 18; and
a request for a best inter-cell mobility candidate target cell 18 at a time of the radio related failure being determined.

Example F8. The wireless device 22 of any one of Examples F1-F5, wherein the performing of the at least one wireless device 22 action includes:
causing transmission, to the source network node 16, of a third indication of the first radio related failure;
receiving, from the source network node 16, in response to the third indication, a fourth indication indicating a second inter-cell mobility candidate target cell 18; and
attempting to execute a second first inter-cell mobility change procedure with the second inter-cell mobility candidate target cell 18 based on the third indication.

Example F9. The wireless device 22 of any one of Examples F1-F8, wherein:
the wireless device 22 is configured with a plurality of inter-cell mobility candidate target cells 18 and a cell selection procedure; and
the performing of the at least one wireless device 22 action including:
   determining a second target cell 18 based on the cell selection procedure;
   optionally, causing transmission of a fifth indication to a second target network node 16 associated with the second target cell 18 indicating the radio related failure;
   optionally, receiving, in response to the transmission of the fifth indication, a sixth indication from the second target network node 16 indicating the wireless device 22 is permitted to execute the inter-cell mobility serving cell 18 change procedure to the second target cell 18; and
   attempting to execute a second inter-cell mobility change procedure with the determined second target cell 18.

Example F10. The wireless device 22 of Example F9, wherein the cell selection procedure includes at least one of:
prioritizing a candidate cell 18 which is one of plurality of inter-cell mobility candidate target cells 18 over another cell 18 which is not one of the plurality of inter-cell mobility candidate target cells 18;
prioritizing a candidate cell 18 which has a higher signal quality metric, the metric being at least one of Reference signal received power (RSRP), Reference Signal Received Quality (RSRQ), and/or Signal to Interference and Noise Ratio (SINR); and
prioritizing a candidate cell 18 which is one of the plurality of inter-cell mobility candidate target cells 18 over another cell 18 which is a Condition Handover (CHO) candidate cell 18.

Example F11. The wireless device 22 of any one of Examples F1-F10, wherein the performing of the at least one wireless device 22 action includes:
determining a beam, the determined beam being at least one of:
   associated with a synchronization signal block (SSB) with at least one signal quality metric above a configured threshold;
   one of a plurality of available beams, the determined beam having the highest signal quality metric of the plurality of available beams;
   associated to the inter-cell mobility candidate target cell 18; and
   configured as a quasi-co-located (QCL) source of a Transmission Configuration Indicator (TCI) state of the inter-cell mobility candidate target cell 18;
the executing of the second inter-cell mobility serving cell 18 change procedure being based on the determined beam; and
causing transmission of a sixth indication of the selected beam to the target cell 18.

Example F12. The wireless device 22 of any one of Examples F1-F12, wherein the configuration of the inter-cell mobility candidate target cell 18 is a Layer (L1)/Layer (L2) based inter-cell mobility configuration which utilizes L1/L2 signaling.

Example F13. The wireless device 22 of any one of Examples F1-F13, wherein the inter-cell mobility serving cell 18 change procedure is a L1/L2 based inter-cell mobility serving cell 18 change procedure which utilizes L1/L2 signaling.

Example G1. A method implemented in a wireless device 22 configured to communicate with a source network node 16, the wireless device 22 being configured with an inter-cell mobility configuration for handling radio related failures, the method comprising:
attempting to execute the first inter-cell mobility change procedure with a first target network node 16 of a first inter-cell mobility candidate target cell 18 associated with the inter-cell mobility configuration;
determining a first radio related failure associated with the first target network node 16, the first inter-cell mobility candidate target cell 18, and/or the inter-cell mobility change procedure; and
performing at least one wireless device 22 action based on the inter-cell mobility configuration and the determined first radio related failure.

Example G2. The method of Example G1, the method further comprising:
receiving a first lower layer signal from a source network node 16 requesting execution of a first inter-cell mobility change procedure; and
the attempting to execute the first inter-cell mobility change procedure being based on the receiving of the first lower layer signal.

Example G3. The method of Example G2, wherein the first lower layer signal from the source network node 16 indicates at least one of the first target network node 16 and the first inter-cell mobility candidate target cell 18.

Example G4. The method of any one of Examples G1-G3, further comprising:
detecting a source cell 18 radio related failure of a source cell 18 associated with the source network node 16; and
the attempting to execute the first inter-cell mobility change procedure being based on the detecting of the source cell 18 radio related failure.

Example G5. The method of any one of Examples G1-G4, wherein the first radio related failure is at least one of:
a beam failure detection (BFD);
a failure to execute the first inter-cell mobility serving cell 18 change procedure;
a handover failure (HOF) and/or an expiration of a timer associated with the HOF;
a radio link failure (RLF) and/or an expiration of a timer associated with the RLF; and
a failure to transmit a maximum number N of Radio Link Control (RLC) Protocol Data Units (PDU).

Example G6. The method of any one of Examples G1-G5, wherein the performing of the at least one wireless device 22 action includes:
determining a second inter-cell mobility target cell 18 associated with the inter-cell mobility configuration; and
cause transmission of a second indication of the first radio related failure to a second target network node 16 associated with the second inter-cell mobility target cell 18.

Example G7. The method of Example G6, wherein the second indication includes at least one of:
a type of the first radio related failure;
a most recent available measurement on the first inter-cell mobility candidate target cell 18; and
a request for a best inter-cell mobility candidate target cell 18 at a time of the radio related failure being determined.

Example G8. The method of any one of Examples G1-G5, wherein the performing of the at least one wireless device 22 action includes:
causing transmission, to the source network node 16, of a third indication of the first radio related failure;
receiving, from the source network node 16, in response to the third indication, a fourth indication indicating a second inter-cell mobility candidate target cell 18; and
attempting to execute a second first inter-cell mobility change procedure with the second inter-cell mobility candidate target cell 18 based on the third indication.

Example G9. The method of any one of Examples G1-G8, wherein:
the wireless device 22 is configured with a plurality of inter-cell mobility candidate target cells 18 and a cell selection procedure; and
the performing of the at least one wireless device 22 action including:
   determining a second target cell 18 based on the cell selection procedure;
   optionally, causing transmission of a fifth indication to a second target network node 16 associated with the second target cell 18 indicating the radio related failure;
   optionally, receiving, in response to the transmission of the fifth indication, a sixth indication from the second target network node 16 indicating the wireless device 22 is permitted to execute the inter-cell mobility serving cell 18 change procedure to the second target cell 18; and
   attempting to execute a second inter-cell mobility change procedure with the determined second target cell 18.

Example G10. The method of Example G9, wherein the cell selection procedure includes at least one of:
prioritizing a candidate cell 18 which is one of plurality of inter-cell mobility candidate target cells 18 over another cell 18 which is not one of the plurality of inter-cell mobility candidate target cells 18;
prioritizing a candidate cell 18 which has a higher signal quality metric, the metric being at least one of Reference signal received power (RSRP), Reference Signal Received Quality (RSRQ), and/or Signal to Interference and Noise Ratio (SINR); and
prioritizing a candidate cell 18 which is one of the plurality of inter-cell mobility candidate target cells 18 over another cell 18 which is a Condition Handover (CHO) candidate cell 18.

Example G11. The method of any one of Examples G1-G10, wherein the performing of the at least one wireless device 22 action includes:
determining a beam, the determined beam being at least one of:
   associated with a synchronization signal block (SSB) with at least one signal quality metric above a configured threshold;
   one of a plurality of available beams, the determined beam having the highest signal quality metric of the plurality of available beams;
   associated to the inter-cell mobility candidate target cell 18; and
   configured as a quasi-co-located (QCL) source of a Transmission Configuration Indicator (TCI) state of the inter-cell mobility candidate target cell 18;
the executing of the second inter-cell mobility serving cell change procedure being based on the determined beam; and
causing transmission of a sixth indication of the selected beam to the target cell 18.

Example G12. The method of any one of Examples G1-G12, wherein the configuration of the inter-cell mobility candidate target cell 18 is a Layer (L1)/Layer (L2) based inter-cell mobility configuration which utilizes L1/L2 signaling.

Example G13. The method of any one of Examples G1-G13, wherein the inter-cell mobility serving cell change procedure is a L1/L2 based inter-cell mobility serving cell change procedure which utilizes L1/L2 signaling.

Example H1. A source network node 16 configured to communicate with a wireless device 22, the source network node 16 configured to, and/or comprising a radio interface and/or comprising processing circuitry configured to:
configure the wireless device 22 with a configuration for the wireless device 22 to handle a radio related failure, the configuration indicating an execution of an inter-cell mobility serving cell change procedure after the radio related failure is determined by the wireless device 22; and
perform at least one network node 16 action based on the configuration.

Example H2. The source network node 16 of Example H1, wherein the source network node 16 is further configured to receive an indication from one of a target network node 16 and a third network node 16, the indication indicating that the wireless device 22 has executed the inter-cell mobility serving cell change procedure based on the configuration.

Example H3. The source network node 16 of Example H2, wherein the indication indicates a radio related failure was determined by the wireless device 22.

Example H4. The source network node 16 of any one of Examples H1-H3, wherein the performing of the at least one network node 16 action includes causing transmission, to a source central unit (CU), of an indication that the wireless device 22 has executed the inter-cell mobility serving cell procedure.

Example H5. The source network node 16 of any one of Examples H1-H4, further configured to:
receive an indication, from the wireless device 22, of a determined radio related failure, the indication indicating that the wireless device 22 failed to execute the inter-cell mobility serving cell change procedure on a first target cell 18; and
in response to receiving the indication, cause transmission, to the wireless device 22, of a request for the wireless device 22 to execute an inter-cell mobility serving cell change procedure for a different target cell 18.

Example H6. The source network node 16 of any one of Examples H1-H5, wherein the configuration of the inter-cell mobility candidate target cell 18 is a Layer (L1)/Layer (L2) based inter-cell mobility configuration which utilizes L1/L2 signaling, and the inter-cell mobility serving cell change procedure is a L1/L2 based inter-cell mobility serving cell change procedure which utilizes L1/L2 signaling.

Example I1. A method implemented in a source network node 16 configured to communicate with a wireless device 22, the method comprising:
configuring the wireless device 22 with a configuration for the wireless device 22 to handle a radio related failure, the configuration indicating an execution of an inter-cell mobility serving cell change procedure after the radio related failure is determined by the wireless device 22; and
performing at least one network node 16 action based on the configuration.

Example I2. The method of Example I1, wherein the source network node 16 is further configured to receive an indication from one of a target network node 16 and a third network node 16, the indication indicating that the wireless device 22 has executed the inter-cell mobility serving cell change procedure based on the configuration.

Example I3. The method of Example I2, wherein the indication indicates a radio related failure was determined by the wireless device 22.

Example I4. The method of any one of Examples 11-13, wherein the performing of the at least one network node 16 action includes causing transmission, to a source central unit (CU), of an indication that the wireless device 22 has executed the inter-cell mobility serving cell procedure.

Example I5. The method of any one of Examples 11-14, further configured to:
receive an indication, from the wireless device 22, of a determined radio related failure, the indication indicating that the wireless device 22 failed to execute the inter-cell mobility serving cell change procedure on a first target cell 18; and
in response to receiving the indication, cause transmission, to the wireless device 22, of a request for the wireless device 22 to execute an inter-cell mobility serving cell change procedure for a different target cell 18.

Example I6. The method of any one of Examples 11-15, wherein the configuration of the inter-cell mobility candidate target cell 18 is a Layer (L1)/Layer (L2) based inter-cell mobility configuration which utilizes L1/L2 signaling, and the inter-cell mobility serving cell change procedure is a L1/L2 based inter-cell mobility serving cell change procedure which utilizes L1/L2 signaling.

Example J1. A serving network node 16 configured to communicate with a wireless device 22, the serving network node 16 being configured to, and/or comprising a radio interface and/or comprising processing circuitry configured to:
determine a configuration of an inter-cell mobility candidate target cell 18, the configuration including a first indication indicating an execution of an inter-cell mobility serving cell change procedure after a radio related failure is determined by the wireless device 22; and
cause transmission, to a source network node 16 and/or the wireless device 22, of the configuration.

Example J2. The serving network node 16 of Example J1, wherein the serving network node 16 is a Central Unit (CU) and/or a serving gNB-CU.

Example J3. The serving network node 16 of any one of Examples C1 and C2, wherein the first indication is one of:
common for a plurality of inter-cell mobility candidate cells 18; and
is specific for an inter-cell mobility candidate cell 18.

Example J4. The serving network node 16 of any one of Examples J1-J3, wherein the serving network node 16 is further configured to at least one of:
receive, from a first target network node 16 or a second target network node 16, a second indication that the wireless device 22 has executed the inter-cell mobility serving cell change procedure; and
cause transmission, to a source network node 16, of a third indication that the wireless device 22 has executed the inter-cell mobility serving cell change procedure.

Example J5. The serving network node 16 of Example J5, wherein at least one of the second indication and the third indication indicates that a radio related failure was determined by the wireless device 22.

Example J6. The serving network node 16 of any one of Examples J1-J5, wherein the configuration of the inter-cell mobility candidate target cell 18 is a Layer (L1)/Layer (L2) based inter-cell mobility configuration which utilizes L1/L2 signaling, and the inter-cell mobility serving cell change procedure is a L1/L2 based inter-cell mobility serving cell change procedure which utilizes L1/L2 signaling.

Example K1. A method implemented in a serving network node 16 configured to communicate with a wireless device 22, method comprising:
determining a configuration of an inter-cell mobility candidate target cell 18, the configuration including a first indication indicating an execution of an inter-cell mobility serving cell change procedure after a radio related failure is determined by the wireless device 22; and
causing transmission, to a source network node 16 and/or the wireless device 22, of the configuration.

Example K2. The method of Example K1, wherein the serving network node 16 is a Central Unit (CU) and/or a serving gNB-CU.

Example K3. The method of any one of Examples K1 and K2, wherein the first indication is one of:
common for a plurality of inter-cell mobility candidate cells 18; and
is specific for an inter-cell mobility candidate cell 18.

Example K4. The method of any one of Examples K1-K3, wherein the serving network node 16 is further configured to at least one of:
receive, from a first target network node 16 or a second target network node 16, a second indication that the wireless device 22 has executed the inter-cell mobility serving cell change procedure; and
cause transmission, to a source network node 16, of a third indication that the wireless device 22 has executed the inter-cell mobility serving cell change procedure.

Example K5. The method of Example K5, wherein at least one of the second indication and the third indication indicates that a radio related failure was determined by the wireless device 22.

Example K6. The method of any one of Examples K1-K5, wherein the configuration of the inter-cell mobility candidate target cell 18 is a Layer (L1)/Layer (L2) based inter-cell mobility configuration which utilizes L1/L2 signaling, and the inter-cell mobility serving cell change procedure is a L1/L2 based inter-cell mobility serving cell change procedure which utilizes L1/L2 signaling.

Example L1. A first target network node 16 configured to communicate with a wireless device 22, the first target network node 16 being configured to, and/or comprising a radio interface and/or comprising processing circuitry configured to:
receive, from the wireless device 22, a first indication that the wireless device 22 has executed an inter-cell mobility serving cell change procedure; and
perform at least one network node 16 action based on the receiving of the first indication.

Example L2. The first target network node 16 of Example L1, wherein the first target network node 16 is at least one of a target gNB, a target distributed unit (DU), and a target central unit (CU).

Example L3. The first target network node 16 of any one of Examples L1 and L2, wherein the performing of the at least one network node 16 action includes:
causing transmission, to a source network node 16 or a third network node 16, of a second indication that the wireless device 22 has executed the inter-cell mobility serving cell change procedure.

Example L4. The first target network node 16 of any one of Examples L1-L3, wherein the first target network node 16 receives, from a third network node 16, a third indication that the wireless device 22 has executed the inter-cell mobility serving cell change procedure.

Example L5. The first target network node 16 of any one of Examples L1-L4, wherein at least one of the first indication, the second indication, and the third indication indicates that a radio related failure was determined by the wireless device 22.

Example L6. The first target network node 16 of any one of Examples L1-L5, wherein the first target network node 16 is configured and/or configured the wireless device 22 with a configuration of an inter-cell mobility candidate target cell 18 including an indication that the wireless device 22 is allowed to perform the inter-cell mobility serving cell change procedure of at least one candidate target cell 18 when the wireless device 22 determines a radio related failure.

Example L7. The first target network node 16 of Example L6, wherein the configuration of the inter-cell mobility candidate target cell 18 is a Layer (L1)/Layer (L2) based inter-cell mobility configuration which utilizes L1/L2 signaling.

Example L8. The first target network node 16 of any one of Examples L1-L7, wherein the inter-cell mobility serving cell change procedure is a L1/L2 based inter-cell mobility serving cell change procedure which utilizes L1/L2 signaling.

Example M1. A method implemented in a first target network node 16 configured to communicate with a wireless device 22, the method comprising:
receiving, from the wireless device 22, a first indication that the wireless device 22 has executed an inter-cell mobility serving cell change procedure; and
performing at least one network node 16 action based on the receiving of the first indication.

Example M2. The method of Example M1, wherein the first target network node 16 is at least one of a target gNB, a target distributed unit (DU), and a target central unit (CU).

Example M3. The method of any one of Examples M1 and M2, wherein the performing of the at least one network node 16 action includes:
causing transmission, to a source network node 16 or a third network node 16, of a second indication that the wireless device 22 has executed the inter-cell mobility serving cell change procedure.

Example M4. The method of any one of Examples M1-M3, wherein the first target network node 16 receives, from a third network node 16, a third indication that the wireless device 22 has executed the inter-cell mobility serving cell change procedure.

Example M5. The method of any one of Examples M1-M4, wherein at least one of the first indication, the second indication, and the third indication indicates that a radio related failure was determined by the wireless device 22.

Example M6. The method of any one of Examples M1-M5, wherein the first target network node 16 is configured and/or configured the wireless device 22 with a configuration of an inter-cell mobility candidate target cell 18 including an indication that the wireless device 22 is allowed to perform the inter-cell mobility serving cell change procedure of at least one candidate target cell 18 when the wireless device 22 determines a radio related failure.

Example M7. The method of Example M6, wherein the configuration of the inter-cell mobility candidate target cell 18 is a Layer (L1)/Layer (L2) based inter-cell mobility configuration which utilizes L1/L2 signaling.

Example M8. The method of any one of Examples M1-M7, wherein the inter-cell mobility serving cell change procedure is a L1/L2 based inter-cell mobility serving cell change procedure which utilizes L1/L2 signaling.

Example N1. A second target network node 16 configured to communicate with a wireless device 22, the second target network node 16 being configured to, and/or comprising a radio interface and/or comprising processing circuitry configured to:
receive, from the wireless device 22, a first indication that the wireless device 22 has executed an inter-cell mobility serving cell change procedure; and
perform at least one network node 16 action based on the receiving of the first indication.

Example N2. The second target network node 16 of Example N1, wherein the second target network node 16 is at least one of a target gNB, a target distributed unit (DU), and a target central unit (CU).

Example N3. The second target network node 16 of any one of Examples N1 and N2, wherein the performing of the at least one network node 16 action includes:
causing transmission, to a source network node 16 or a third network node 16, of a second indication that the wireless device 22 has executed the inter-cell mobility serving cell change procedure.

Example N4. The second target network node 16 of any one of Examples N1-N3, wherein the second target network node 16 receives, from a third network node 16, a third indication that the wireless device 22 has executed the inter-cell mobility serving cell change procedure.

Example N5. The second target network node 16 of any one of Examples N1-N4, wherein at least one of the first indication, the second indication, and the third indication indicates that a radio related failure was determined by the wireless device 22.

Example N6. The second target network node 16 of any one of Examples N1-N5, wherein the second target network node 16 is configured and/or configured the wireless device 22 with a configuration of an inter-cell mobility candidate target cell 18 including an indication that the wireless device 22 is allowed to perform the inter-cell mobility serving cell change procedure of at least one candidate target cell 18 when the wireless device 22 determines a radio related failure.

Example N7. The second target network node 16 of Example N6, wherein the configuration of the inter-cell mobility candidate target cell 18 is a Layer (L1)/Layer (L2) based inter-cell mobility configuration which utilizes L1/L2 signaling.

Example N8. The second target network node 16 of any one of Examples N1-N7, wherein the inter-cell mobility serving cell change procedure is a L1/L2 based inter-cell mobility serving cell change procedure which utilizes L1/L2 signaling.

Example O1. A method implemented in a second target network node 16 configured to communicate with a wireless device 22, the method comprising:
receiving, from the wireless device 22, a first indication that the wireless device 22 has executed an inter-cell mobility serving cell change procedure; and
performing at least one network node 16 action based on the receiving of the first indication.

Example O2. The method of Example O1, wherein the second target network node 16 is at least one of a target gNB, a target distributed unit (DU), and a target central unit (CU).

Example O3. The method of any one of Examples O1 and 02, wherein the performing of the at least one network node 16 action includes:
causing transmission, to a source network node 16 or a third network node 16, of a second indication that the wireless device 22 has executed the inter-cell mobility serving cell change procedure.

Example O4. The method of any one of Examples 01-03, wherein the second target network node 16 receives, from a third network node 16, a third indication that the wireless device 22 has executed the inter-cell mobility serving cell change procedure.

Example O5. The method of any one of Examples 01-04, wherein at least one of the first indication, the second indication, and the third indication indicates that a radio related failure was determined by the wireless device 22.

Example O6. The method of any one of Examples 01-05, wherein the second target network node 16 is configured and/or configured the wireless device 22 with a configuration of an inter-cell mobility candidate target cell 18 including an indication that the wireless device 22 is allowed to perform the inter-cell mobility serving cell change procedure of at least one candidate target cell 18 when the wireless device 22 determines a radio related failure.

Example O7. The method of Example O6, wherein the configuration of the inter-cell mobility candidate target cell 18 is a Layer (L1)/Layer (L2) based inter-cell mobility configuration which utilizes L1/L2 signaling.

Example O8. The method of any one of Examples 01-07, wherein the inter-cell mobility serving cell change procedure is a L1/L2 based inter-cell mobility serving cell change procedure which utilizes L1/L2 signaling.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
5GC or 5GCN 5G core network
ACK Acknowledgement
AGC Automatic Gain Control
AMF Access and Mobility management Function
AP Application Protocol
ARQ Automatic Repeat Request
BFD Beam Failure Monitoring
BFR Beam Failure Recovery
BSR Buffer Status Report
BWP Bandwidth Part
C-RNTI Cell Radio Network Temporary Identifier
CA Carrier Aggregation
CE Control Element
CGI Cell Global Identity
CHO Conditional Handover
CN Core Network
CPA Conditional PSCell 18Addition
CPC Conditional PSCell Change
CP Control Plane
CQI Channel Quality Indicator
C-RNTI Cell Radio Network Temporary Identifier
CSI Channel State Information
CU Central Unit
DC Dual Connectivity
DCI Downlink Control Information
DL Downlink
DRB Data Radio Bearer
DU Distributed Unit
eNB (EUTRAN) base station
E-RAB EUTRAN Radio Access Bearer
E-UTRA Evolved Universal Terrestrial Radio Access
E-UTRAN Evolved Universal Terrestrial Radio Access Network
FDD Frequency Division Duplex
gNB NR base station
GTP-UGPRS Tunneling Protocol-User Plane
HARQ Hybrid ARQ
IE Information Element
IP Internet Protocol
LTE Long Term Evolution
MCG Master Cell Group
MAC Medium Access Control
MAC CE MAC Control Element
MeNB Master eNB
MgNB Master gNB
MN Master Node
MR-DC Multi-Radio Dual Connectivity
NACK Negative Acknowledgement
NAS Non Access Stratum
NG-RAN Next Generation Radio Access Network
Ng-eNB Next Generation Evolved Node B
NR New Radio
PDCP Packet Data Convergence Protocol
PCell Primary Cell
PCI Physical Cell Identity
PDCCH Physical Downlink Control Channel
PHR Power headroom report
PSCell Primary Secondary Cell (in LTE) or Primary SCG Cell (in NR)
PUCCH Physical Uplink Control Channel
PUSCH Physical Uplink Shared Channel
RACH Random Access Channel
RAT Radio Access Technology
RB Radio Bearer
RLC Radio Link Control
RLF Radio Link Failure
RRC Radio Resource Control
SCell Secondary Cell
Secondary Cell Group SCG
SCTP Stream Control Transmission Protocol
SeNB Secondary eNB
SgNB Secondary gNB
SINR Signal to Interference plus Noise Ratio
SN Secondary Node
SR Scheduling Request
SRB Signaling Radio Bearer
SSB Synchronization Signal Block
S-SN Source Secondary Node
SUL Supplementary uplink
SpCell Special Cell, the primary cell of a master or secondary cell group
TAT Time Alignment Timer
TCI Transmission Configuration Indication
TDD Time Division Duplex
TEID Tunnel Endpoint IDentifier
TNL Transport Network Layer
T-SN Target Secondary Node
UCI Uplink Control Information
UDP User Datagram Protocol
UPF User Plane Function
UE User Equipment
UL Uplink
UL-SCH Uplink Shared Channel
UP User Plane
URLLC Ultra Reliable Low Latency Communication
X2 Interface between base stations

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-58. (canceled)

59. A method implemented in a wireless device configured with a Layer 1/Layer 2 (L1/L2)-based inter-cell mobility configuration for handling radio related failures, the L1/L2-based inter-cell mobility configuration indicating a plurality of candidate target cells and a source cell, the method comprising:
detecting a radio related failure of the source cell;
performing at least one wireless device action based on the L1/L2-based inter-cell mobility configuration and the detected radio related failure, wherein the at least one wireless device action comprises:
initiating one of the following procedures: a radio resource control (RRC) re-establishment procedure, or a condition handover (CHO) procedure;
selecting a first cell of a plurality of available cells;
selectively executing one of multiple procedures based on whether the first cell is one of the plurality of candidate target cells indicated by the L1/L2-based inter-cell mobility configuration, comprising:
executing an L1/L2-based inter-cell mobility serving cell change procedure, based on the first cell being one of the plurality of candidate target cells indicated by the L1/L2-based inter-cell mobility configuration; and
continuing the initiated procedure by causing transmission of an RRC re-establishment request to the first cell, based on the first cell not being one of the plurality of candidate target cells indicated by the L1/L2-based inter-cell mobility configuration.

60. The method of claim 59, wherein the radio related failure comprises at least one of the following:
a beam failure detection (BFD);
a failure to execute an L1/L2-based inter-cell mobility serving cell change procedure;
a handover failure (HOF);
a radio link failure (RLF); and
a failure to transmit a maximum number N of radio link control (RLC) protocol data units.

61. The method of claim 60, wherein the at least one wireless device action further comprises causing transmission by the wireless device of a first indication that the wireless device has executed the L1/L2-based inter-cell mobility serving cell change procedure, whether the first indication is transmitted to one of the following:
a source network node associated with the source cell,
a first target network node associated with a first one of the plurality of candidate target cells, and
a second target network node associated with a second one of the plurality of candidate target cells.

62. The method of claim 59, wherein:
the at least one wireless device action further comprises transmitting a second indication that the wireless device has detected the radio related failure, the second indication indicating at least one of the following:
a type of the radio related failure;
measurement data associated with at least one of the plurality of candidate target cells; and
a requested candidate target cell of the plurality of candidate target cells.
the second indication is transmitted to at least one of the following:
a source network node associated with the source cell,
a first target network node associated with a first one of the plurality of candidate target cells, and
a second target network node associated with a second one of the plurality of candidate target cells.

63. The method of claim 62, further comprising:
receiving a first message responsive to the second indication, wherein the first message is received from the source network node, the first target network node, or the second target network node; and
responsive to the first message, determining whether to execute the L1/L2-based inter-cell mobility serving cell change procedure to an L1/L2-based inter-cell mobility candidate target cell.

64. The method of claim 59, further comprising receiving the L1/L2-based inter-cell mobility configuration from a source network node associated with the source cell, wherein the L1/L2-based inter-cell mobility configuration indicates that the wireless device is permitted to perform the L1/L2-based inter-cell mobility serving cell change procedure when at least one radio related failure has been detected.

65. The method of claim 59, wherein the first cell is selected from the plurality of available cells based on at least one of the following:
the first cell being one of the plurality of candidate target cells of the L1/L2-based inter-cell mobility configuration;
the first cell being prioritized over any of the plurality of available cells that are not among the plurality of candidate target cells indicated by the L1/L2-based inter-cell mobility configuration;
at least one of the following measurements of the first cell: reference signal received power (RSRP), reference signal received quality (RSRQ), and signal to interference and noise ratio (SINR); and
a priority index associated with the first cell.

66. The method of claim 65, wherein the radio related failure is one of the following:
a master cell group radio link failure, wherein the plurality of candidate target cells are primary cells (PCells);
a secondary cell group radio link failure, wherein the plurality of candidate target cells are primary secondary cell group cells (PSCells); and
a secondary cell radio link failure, wherein the plurality of candidate target cells are secondary cells (SCells).

67. A wireless device comprising processing circuitry configured to perform the method of claim 59.

68. A method implemented in a source network node configured to communicate with a wireless device, the method comprising:
configuring the wireless device with a configuration for execution of a Layer 1/Layer 2 (L1/L2)-based inter-cell mobility serving cell change procedure after a radio related failure is detected by the wireless device, wherein the configuration indicates at least one target candidate cell for inter-cell mobility switching;
performing at least one network node action based on the configuration, wherein the at least one network node action comprises receiving a first indication that the wireless device detected a radio related failure and executed the L1/L2-based inter-cell mobility serving cell change procedure based on the configuration, wherein the first indication is received from one of the following:
a target network node configured to provide the target candidate cell for the L1/L2-based inter-cell mobility serving cell change procedure executed by the wireless device, and
a third network node configured as a central unit (CU) for at least the source network node,

69. The method of claim 68, wherein when the first indication is received from the target network node, the at least one network node action further comprises transmitting, to the third network node, a second indication that the wireless device has executed the L1/L2-based inter-cell mobility serving cell procedure.

70. The method of claim 68, wherein the at least one network node action further comprises:
receiving from the wireless device a third indication that the wireless device detected the radio related failure but failed to execute the L1/L2-based inter-cell mobility serving cell change procedure towards a first one of the target candidate cells; and
in response to receiving the third indication, transmitting to the wireless device a request to execute an L1/L2-based inter-cell mobility serving cell change procedure towards a different one of the target candidate cells than the first target candidate cell.

71. A source network node comprising processing circuitry configured to perform the method of claim 68.

72. A method implemented in a serving network node configured to communicate with a wireless device, the method comprising:
determining a configuration for execution of a Layer 1/Layer 2 (L1/L2)-based inter-cell mobility serving cell change procedure after a radio related failure is detected by the wireless device, wherein the configuration indicates at least one target candidate cell for inter-cell mobility switching; and
transmitting the configuration to at least one of the following: the wireless device, and a source network node configured to provide a source cell for the wireless device.

73. The method of claim 72, wherein the serving network node is a Central Unit (CU) of a gNB.

74. The method of claim 72, wherein the first indication indicates one of the following:
a plurality of target candidate cells for inter-cell mobility switching; and
a single target candidate cell for inter-cell mobility switching.

75. The method of claim 72, further comprising at least one of the following:
receiving, from a target network node, a second indication that the wireless device has executed the L1/L2-based inter-cell mobility serving cell change procedure to one of the target candidate cells that is provided by the target network node; and
transmitting, to the source network node, a third indication that the wireless device has executed the L1/L2-based inter-cell mobility serving cell change procedure to the target candidate cell provided by the target network node.

76. A serving network node comprising processing circuitry configured to perform the method of claim 72.

77. A method implemented in a first target network node configured to communicate with a wireless device, the method comprising:
configuring the wireless device with a configuration for execution of a Layer 1/Layer 2 (L1/L2)-based inter-cell mobility serving cell change procedure after a radio related failure is detected by the wireless device, wherein the configuration indicates at least one target candidate cell for inter-cell mobility switching;
receiving, from the wireless device, a first indication indicating that the wireless device has executed an L1/L2-based inter-cell mobility serving cell change procedure responsive to the detecting a radio related failure; and
performing at least one network node action based on the first indication.

78. The method of claim 77, wherein the first target network node is one of the following: a target gNB, a distributed unit (DU) of a target gNB, or a central unit (CU) of a target gNB.

79. The method of claim 77, wherein the at least one network node action comprises transmitting a second indication that the wireless device has executed the L1/L2-based inter-cell mobility serving cell change procedure, wherein the second indication is transmitted to one of the following:
a source network node configured to provide a source cell for the L1/L2-based inter-cell mobility serving cell change procedure, and
a third network node configured as a central unit (CU) for at least the source network node.

80. A first target network node comprising processing circuitry configured to perform the method of claim 77.
